(19) United States
(12) Patent Application Publication
(10) Pub. No.: US 2013/0258234 A1
(43) Pub. Date: Oct. 3, 2013

(54) DISPLAY APPARATUS

(71) Applicants: JongSub Park, Jung-ri (KR); ChoelMin Woo, Sangju-si (KR)

(72) Inventors: JongSub Park, Jung-ri (KR); ChoelMin Woo, Sangju-si (KR)

(21) Appl. No.: 13/556,861

(22) Filed: Jul. 24, 2012

(30) Foreign Application Priority Data
Mar. 28, 2012 (KR) 10 2012-0031676

(51) Int. Cl. G02F 1/1335

(52) U.S. Cl. 349/58

(57) ABSTRACT

Disclosed is a display apparatus. The display apparatus includes a display unit and a guide frame. The display unit has a panel provided with lower and upper substrates sealed with having liquid crystal filled therebetween. The guide frame supports the display unit. The guide frame includes a guide sidewall and a panel supporter. The guide side wall guides a lateral side of the panel. The panel supporter supports the panel.

This application claims the priority and the benefit under 35 U.S.C. §119(a) on Korean Patent Application No. 10 2012-0031676 filed on Mar. 28, 2012, the entire contents of which are hereby incorporated by reference.

### BACKGROUND

1. Field of the Invention

The present disclosure relates to a display apparatus, and more particularly, to a borderless type display apparatus with a built-in camera.

2. Discussion of the Related Art

Recently, various flat-type display devices, which substitute for Cathode Ray Tube (CRT), have been actively researched and studied. For example, Liquid Crystal Display (LCD) device, Plasma Display Panel (PDP), Field Emission Display Device (FED), Light Emitting Display (LED) device, and etc. Especially, the LCD device has attracted great attentions owing to the advantageous properties such as mass production technology, simple driving means, and high picture quality.

Recent research and development are required on designs of products appealing to consumers. Consequently, efforts for minimizing the thicknesses (slimness) of LCD devices are continuously being made, and research is being conducted on a design with enhanced sense of beauty that can induce consumers to buy by appealing to consumers' sense of aesthetic.

However, in efforts for minimizing the thicknesses of LCD devices and design development for enhancing a sense of aesthetics that have been made to date, the existing elements have been applied as is, the structures of the elements have only minor changes, and thus, there are limitations in minimizing the thicknesses of the LCD devices and developing new designs of the LCD devices.

For example, a related art LCD device necessarily uses lower and upper cases to receive a liquid crystal display panel and a backlight unit therein. In addition, front and rear set covers are additionally used in the related art LCD device to manufacture a product such as a notebook computer, a monitor, a mobile device, or a television.

As the lower and upper cases and the front and rear set covers for the manufactured device are inevitably used, there are limitations in the slimness of the display device and the advance toward a new design. Specifically, the front edge parts of the liquid crystal display panel are covered with the upper case and the front set cover, whereby the liquid crystal display device is increased in its thickness. Also, the border width of the liquid crystal display device may be increased, so that the difference in height of the stepped portion may cause limitations in advancing toward an innovative design.

Recently, a notebook computer having a camera has been introduced for a video chatting or video conferencing. Thus, since an additional space for the camera is necessarily required in the notebook computer, a border width of a screen in the notebook computer is further increased. Also, due to a step height in a border portion, it becomes more difficult to develop various innovative designs.

In order to overcome this problem, various display apparatuses without the step height on the plane has been researched and studied.

In the case of the display apparatus having a camera mounted on a lower side of a panel, a transmitting hole is formed under the circumstance that black matrix patterns deposited on an upper substrate of the panel are removed from a portion corresponding to the camera, whereby ambient light comes into the camera without being affected by the black matrix.

However, in the case of the above display apparatus according to the related art, there is an empty space between the lower substrate and the black matrix in the periphery of the transmitting hole. If the upper substrate is pushed by an external force, a depression may occur in the periphery of the transmitting hole, whereby a mura defect may occur in a display area adjacent to the transmitting hole.

As mentioned above, since the display apparatus according to the related art has the empty vacuum space between the lower substrate and the black matrix in the periphery of the transmitting hole, a concentric-circle shaped diffraction pattern is generated on an image taken by the camera due to a diffraction of light passing through the glass upper substrate and the transmitting hole.

### BRIEF SUMMARY

A display apparatus comprises: a display unit having a panel having lower and upper substrates sealed with having liquid crystal filled therebetween; and a guide frame, which supports the display unit, wherein the guide frame includes: a guide sidewall, which guides a lateral side of the panel; and a panel supporter, which supports the panel, wherein a camera receiving part with a camera mounted thereon is disposed in a first panel supporter of the panel supporter, a transmitting hole for transmitting light to the camera is disposed in a black matrix of a first non-display area to be placed on the first panel supporter of the upper substrate, a display area of the panel and the first non-display area are filled with liquid crystal, and an upper polarizing film, which covers the display area and the first non-display area in which the transmitting hole is formed, is attached to a upper surface of the upper substrate.

In another aspect of the disclosure, a display apparatus comprises: a display unit having a panel having lower and upper substrates sealed with liquid crystal filled therebetween; and a guide frame, which supports the display unit, wherein the guide frame includes: a guide sidewall, which guides a lateral side of the panel; and a panel supporter, which supports the panel, wherein a camera receiving part with a camera mounted thereon is disposed in a first panel supporter of the panel supporter, a transmitting hole for transmitting light to the camera is disposed in a black matrix of a first non-display area to be placed on the first panel supporter of the upper substrate, a first seal is disposed between a display area of the panel and the first non-display area, and liquid crystal is filled only in the display area, an upper polarizing film, which covers the display area and the first non-display area in which the transmitting hole is formed, is attached to a upper surface of the upper substrate, and the first non-display area is at atmospheric pressure.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a notebook computer with a display apparatus according to an embodiment of the present invention;

FIG. 2 is a cross section view illustrating a display apparatus according to an embodiment the present invention;

FIG. 3 is a detailed cross section view illustrating a display apparatus according to the first embodiment of the present invention;

FIG. 4 is a detailed cross section view illustrating a display apparatus according to the second embodiment of the present invention;

FIG. 5 is a plan view illustrating a lower side of a display apparatus according to the present invention;

FIG. 6 is a detailed cross section view illustrating a display apparatus according to the third embodiment of the present invention;

FIG. 7 is a plan view illustrating a panel applied to a display apparatus according to a fourth embodiment of the present invention;

FIG. 8 is a detailed sectional view illustrating the display apparatus according to the fourth embodiment of the present invention;

FIGS. 9 to 13 are various exemplary views illustrating a first seal formed in a panel of the display apparatus according to the fourth embodiment of the present invention;

FIG. 14 is another detailed sectional view illustrating the display apparatus according to the fourth embodiment of the present invention;

FIG. 15 is another plan view illustrating a panel applied to the display apparatus according to the fourth embodiment of the present invention;

FIG. 16 is another detailed sectional view illustrating the display apparatus according to the fourth embodiment of the present invention;

FIG. 17 is a detailed sectional view illustrating a display apparatus according to a fifth embodiment of the present invention;

FIG. 18 is an exemplary view illustrating a plane of the display apparatus according to the fifth embodiment of the present invention illustrated in FIG. 17;

FIG. 19 is another detailed sectional view illustrating the display apparatus according to the fifth embodiment of the present invention;

FIG. 20 is an exemplary view illustrating a plane of the display apparatus according to the fifth embodiment of the present invention illustrated in FIG. 19;

FIG. 21 is another detailed sectional view illustrating the display apparatus according to the fifth embodiment of the present invention;

FIG. 22 is an exemplary view illustrating a plane of the display apparatus according to the fifth embodiment of the present invention illustrated in FIG. 21;

FIG. 23 is a flowchart illustrating a method of manufacturing a display apparatus according to an embodiment of the present invention; and

FIG. 24 is a table showing various kinds of materials which form one of a filling material, a column spacer, and a transmitting material which are formed in a transmitting hole or a transmitting part, in a display apparatus according to an embodiment of the present invention.

### DETAILED DESCRIPTION OF THE DRAWINGS AND THE PRESENTLY PREFERRED EMBODIMENTS

Reference will now be made in detail to the exemplary embodiments of the present invention, examples of which are illustrated in the accompanying drawings. Wherever possible, the same reference numbers will be used throughout the drawings to refer to the same or like parts.

Hereinafter, a display apparatus according to the present invention will be described in detail with reference to the accompanying drawings.

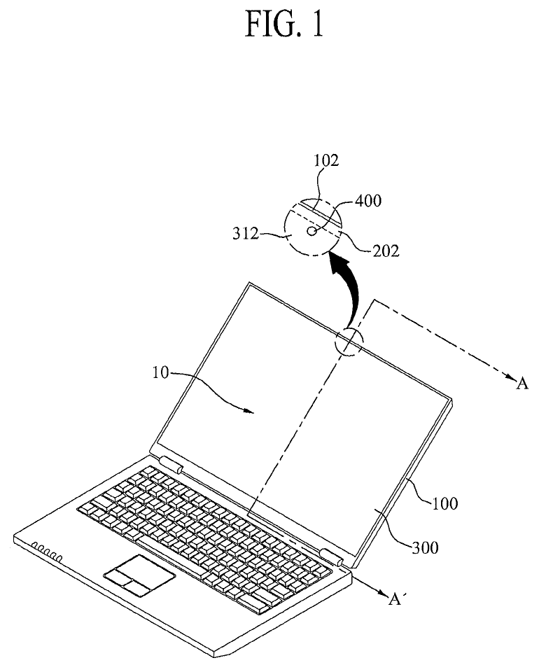

FIG. 1 illustrates a notebook computer with a display apparatus according to an embodiment the present invention.

The display apparatus 10 according to the present invention may be applied to a small-sized terminal such as a notebook computer. Especially, the display apparatus 10 according to the present invention is characterized in that it includes a camera 400, which is formed under a panel of the display apparatus 10, wherein the camera 400 collects user's images.

The display apparatus 10 according to the present invention is characterized in that a plane for forming the exterior is formed without a step height so as to realize a borderless type display apparatus.

As shown in FIG. 1, the above display apparatus 10 according to the present invention may function as a monitor of a small-sized notebook computer. This monitor is formed in such a manner that a set cover 100 covers the display apparatus 10. Also, there is no step height between the set cover 100 and the plane of the display apparatus 10.

As mentioned above, the display apparatus 10 according to the present invention may be formed without the step height on the plane, or may be formed by covering the peripheral portion of the plane with an end of the set cover in type of narrow bezel.

That is, the present invention is for allowing external light to be inputted to a camera lens through a transmitting hole that is formed in a non-display area of the panel. In the present invention, an end of a guide frame or a set cover that will be described below covers a portion of the non-display area of the panel, and thus, a step height may be formed between a plane of the panel and the end of the guide frame or the set cover. Alternatively, a step height may not be formed between a plane of the panel and the end of the guide frame or the set cover.

Hereinafter, there is an explanation for the display apparatus formed by covering the end of the panel with the end of set cover or guide frame without providing the step height on the plane of the panel. However, the present invention may be applied to the display apparatus formed by covering the predetermined portion of the non-display area of the panel with the end of set cover or guide frame with the step height on the plane of the panel.

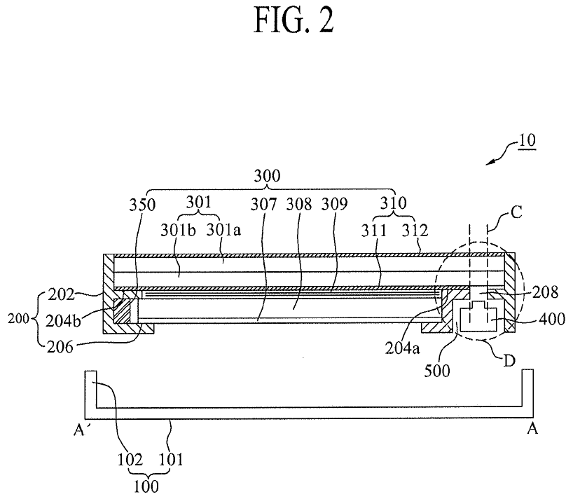

FIG. 2 is a cross section view illustrating a display apparatus according to the present invention, which is a cross section view along A-A′ of FIG. 1.

The display apparatus 10 according to the present invention forms a monitor for outputting images, wherein the monitor is mounted on a small-sized terminal. As shown in FIG. 2, the display apparatus 10 according to the present invention includes a guide frame 200 and a display unit 300, and the display apparatus 10 according to the present invention is mounted on and fixed into a set cover 100. Also, a camera 400 is provided between the set cover 100 and the guide frame 200, or between the guide frame 200 and a panel 301 of the display unit 300. That is, the display apparatus 10 according to the present invention may form a monitor of a small-sized terminal, with being covered by the set cover 100. That is, the display apparatus 10 according to the present invention may include the set cover 100, but the display apparatus 10 without the set cover 100 will be explained as follows. Herein, the set cover 100 covers the exterior of the display apparatus 10. Substantially, the set cover 100 forms the exterior of a terminal such as a monitor of a notebook computer.

First, the set cover 100 is formed in a square-shaped frame, wherein the set cover 100 supports the guide frame 200, and covers a lateral side of the guide frame 200. Thus, the set cover 100 covers the display apparatus 10.

The set cover 100 may be formed of a plasmatic material or metal material, wherein the set cover 100 includes a set plate 101 and a set sidewall 102.

The set plate 101, which is formed in a plate type, serves as a lower cover of the manufactured display apparatus.

The set sidewall 102 is vertically bent from the set plate 101, thereby forming a receiving space. The set sidewall 102 is formed to cover the lateral side of the guide frame 200 to be explained, whereby the set sidewall 102 serves as a lateral cover of the display apparatus.

As shown in FIG. 2, there is no difference in height between an end of the set sidewall 102 and an upper surface of the panel 301. As mentioned above, the end of the set sidewall may be bent toward the inside of the panel of the display apparatus, whereby there may be difference in height between the end of the set sidewall and the upper surface of the panel 301.

Then, the guide frame 200 for supporting the display unit 300 is received in the space prepared by the set cover 100. The guide frame 200 includes a guide sidewall 202, a panel supporter, and a lower supporter 206. Particularly, a camera hole 208 is formed in a portion of the panel supporter on which a camera 400 is mounted.

The guide sidewall 202 is formed in parallel with the set sidewall 102 of the set cover 100. The guide sidewall 202, which is formed in a square-shaped frame, covers the lateral side of the display unit 300. At this time, an upper surface of the guide sidewall 202 covers the lateral side of the display unit 300 while being exposed to the external and being not overlapped with an upper edge of the display unit 300, whereby the upper surface of the guide sidewall 202 forms the border of the display unit 300.

The panel supporter protrudes from the guide sidewall 202 in the opposite direction to the set sidewall 102, whereby the panel supporter supports the panel 301 of the display unit 300. That is, the panel supporter is formed in each of four sides of the guide sidewall 202 of the square-shaped frame, thereby supporting the panel.

The panel supporter includes a first panel supporter 204a, a second panel supporter 204b, a third panel supporter, and a fourth panel supporter.

As shown in FIG. 2, the above camera is arranged in the first panel supporter 204a; and the second panel supporter 204b is arranged in the opposite side to the first panel supporter 204a. That is, the first and second supporters 204a and 204b are formed at the opposite sidewalls among the four sidewalls of the guide sidewall 202 of the square-shaped frame. Also, the third panel supporter (not shown) and the fourth panel supporter (not shown) are formed at the other two sidewalls of the guide sidewall of the square-shaped frame.

Especially, the camera hole 208 is formed in the first panel supporter 204a in which the camera 400 is to be arranged, whereby the lens of the camera 400 is exposed to the external via the panel 301.

In FIG. 2, the camera is arranged below the first panel supporter 204a. However, the camera may be arranged between the first panel supporter and the panel. In this case, the first panel supporter may be formed in the ‘∪’ shape. In case of FIG. 2, since the first panel supporter is formed in the ‘∩’ shape, the camera is placed below the first panel supporter, and the camera hole is formed in the first panel supporter. If the first panel supporter is formed in the ‘∪’ shape, the camera is arranged between the first panel supporter and the panel, and the camera hole is not additionally formed in the first panel supporter.

A room for the camera, which may be formed on or under the first panel supporter, is referred to as a camera receiving part 500. That is, as shown in FIG. 2, the camera receiving part 500 may be provided between the first panel supporter and the set plate 101, or may be provided between the first panel supporter and the panel 301.

That is, the first panel supporter 204a supports the panel 301. Also, the first panel supporter 204a protruding from the guide sidewall 202 may be formed in various shapes for receiving the camera 400 therein.

The lower supporter 206 protrudes from the lower end of the panel supporter or the lower end of the guide sidewall in the opposite direction to the set sidewall 102, wherein the lower supporter 206 is provided below the panel supporter. The lower supporter 206 supports a reflective plate 307, a light-guiding plate 308, an optical film 309, and a light source 350.

That is, the lower supporter 206 is provided below the panel supporter, and the lower supporter 206 supports the above reflective plate 307, the light-guiding plate 308, the optical film 309, and the light source 350. If the lower supporter 206 protrudes from the first panel supporter 204a for receiving the camera 400, as shown in FIG. 2, the lower supporter 206 protrudes from the lower end of the first panel supporter in the opposite direction to the set sidewall. In addition, the lower supporter 206 may protrude from the guide sidewall 202 in the lower side of the panel supporter while being in the opposite direction to the set sidewall 102.

Although not shown, the first panel supporter 204a may have additional rooms at both sides of the camera receiving part 500, wherein the additional rooms are similar in shape to the camera receiving part. In this case, antenna or antenna wire may be arranged in these additional rooms of the first panel supporter.

The display unit 300 may include the panel 301; polarizing film 310; the optical film 309, the light-guiding plate 308, the reflective plate 307, and the light source 350.

The panel 301 is formed by bonding an upper substrate 301a and a lower substrate 301b to each other. The panel 301 includes a display area in which various devices are formed; and a non-display area which is formed in the periphery of the display area. The non-display area is divided into a first non-display area, a second non-display area, a third non-display area, and a fourth non-display area. The first panel supporter 204a is placed on the first non-display area; the second panel supporter 204b is placed on the second non-display area; the third panel supporter is placed on the third non-display area; and the fourth panel supporter is placed on the fourth non-display area.

According as liquid crystal injected between the upper and lower substrates 301a and 301b is driven by a voltage applied to the lower substrate, the panel 301 outputs an image in accordance with a transmission amount of light emitted from the light source 350, wherein the panel 301 may be formed in various types.

The light source 350 is provided to supply the light to the panel. In this case, various kinds of light source may be used. Recently, a light-emitting diode (LED) is used for the light source 350.

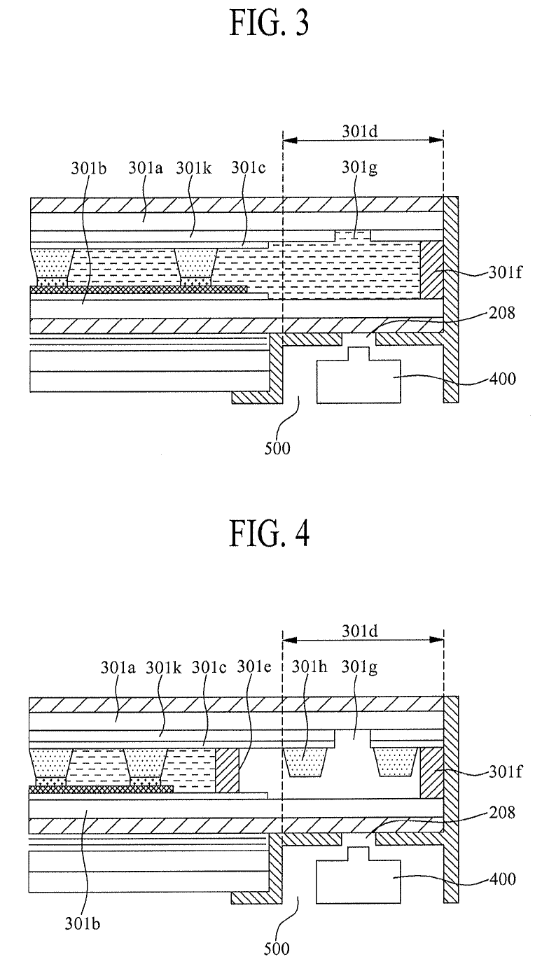

The light-guiding plate 308 diffuses and reflects the light emitted from the light source 350 toward the panel. That is, as shown in FIGS. 2 and 3, the light-guiding plate 308 is provided in a side-light type display apparatus in which the light source 350 is formed at a lateral side thereof, wherein the light-guiding plate 308 guides the light emitted from the light source toward the panel.

The optical film 309 diffuses the light passing through the light-guiding plate 308, or enables the vertical incidence of the light passing through the light-guiding plate 308 on the panel 301. The optical film 309 may include a diffusion sheet, a prism sheet, and etc., wherein the optical film 309 may vary in structure.

The reflective plate 307 is provided on a lower surface of the light-guiding plate, wherein the reflective plate 307 reflects the light emitted from the light source toward the panel. That is, the light, which is emitted from the light source and is then incident on the light-guiding plate, is refracted by a pattern on the light-guiding plate, and is reflected toward the panel. However, there may be the light discharged to the external through the lower surface of the light-guiding plate without being reflected. In this case, the reflective plate re-reflects the light toward the panel.

The polarizing film 310 is attached to the plane or lower surface of the panel including the liquid crystal. The polarizing film 310 transmits predetermined ingredients of light according as the voltage applied to the panel is turned-on/off.

The present invention is characterized by the display unit 300, especially, the structure of the panel 301. The detailed structure of the display apparatus according to the present invention will be described with reference to FIGS. 3 to 24.

FIG. 3 is a detailed cross section view illustrating a display apparatus according to the first embodiment of the present invention, which illustrates the detail of portion D′ of FIG. 2.

That is, FIG. 3 is a detailed cross section view illustrating the display apparatus according to the first embodiment of the present invention, especially, the detailed cross section view of the panel.

First, the panel includes the upper substrate 301a, the lower substrate 301b, and the liquid crystal layer between the upper substrate 301a and the lower substrate 301b.

The lower substrate is a base substrate configuring a driving device array substrate. Although not shown in detail, there are plural pixels on the lower substrate, wherein each pixel includes a driving device such as a thin film transistor.

The upper substrate is a base substrate configuring a color filter substrate, wherein a color filter layer for realizing color is formed on the upper substrate.

On each of the lower substrate 301b and the upper substrate 301a, there are pixel electrodes, common electrodes, and an alignment layer coated for alignment of liquid crystal molecules included in the liquid crystal layer. The lower substrate and the upper substrate are bonded to each other by the use of sealant formed in the periphery of the substrate. Between the lower substrate 301b and the upper substrate 301a, there is a spacer for maintaining a cell gap therebetween.

In the panel 301 having the above structure, the liquid crystal molecules are driven by the driving device on the lower substrate, and thus, information is displayed by controlling the amount of light passing through the liquid crystal layer.

In the above structure of the panel, the lower substrate is formed by a driving device array substrate process, and the upper substrate is formed by a color filter substrate process for forming the color filter.

The driving device array substrate process includes steps of forming a plurality of gate lines and data lines to define pixel regions on the lower substrate; forming the thin film transistor corresponding to the driving device, which is connected with the gate and data lines, in each pixel region; and forming the pixel electrode connected with the thin film transistor, wherein the pixel electrode drives the liquid crystal layer in accordance with a signal applied via the thin film transistor.

The color filter substrate process includes steps of forming a black matrix on the upper substrate; forming the color filter thereon; and forming the common electrode.

On the upper substrate of the panel applied to the display apparatus according to the first embodiment of the present invention, the black matrix 301k is coated thereon, and the black matrix 301k is formed in the first non-display area of the panel. Also, a transmitting hole 301g is formed at a position corresponding to the camera in the black matrix of the first non-display area. The transmitting hole 301g may be formed by an etching process of the color filter substrate process. That is, the black matrix 301k, the color filter (not shown), and the common electrode 301c are deposited on the upper substrate 301a; and then the transmitting hole 301g is formed by the etching process using a mask. In this case, the transmitting hole 301g is formed when the black matrix 301k is etched together with the color filter (not shown) or the common electrode.

The spacer for maintaining the constant cell gap between the upper substrate 301a and the lower substrate 301b is formed on the common electrode or a planarization layer of the upper substrate. Preferably, the spacer is formed as a column spacer. The column spacers may be provided on desired portions of the entire surface of the panel at the constant density. That is, since the column spacers are provided on the desired portions, the constant cell gap is maintained between the lower substrate 301b and the upper substrate 301a, thereby preventing an aperture ratio from being deteriorated.

On the lower substrate 301b, there may be a protrusion corresponding to the column spacer. This protrusion prevents a press defect when the column spacer contacts with the substrate.

As mentioned above, the column spacer deposited on the upper substrate may directly contact with the lower substrate so as to maintain the cell gap between the lower substrate and the upper substrate, or may contact with the protrusion so as to maintain the cell gap between the lower substrate and the upper substrate.

That is, the panel 301 is formed by bonding the upper substrate 301a having the column spacer deposited thereon with the lower substrate 301b.

Thereafter, the edge of the panel 301 is sealed by a seal 301f, and then the liquid crystal is injected into the inside of the panel 301 via an inlet under the circumstance that the edge of the panel 301 is sealed. Then, the panel 301 is completed by sealing the inlet.

As shown in FIG. 3, the present invention is characterized in that the liquid crystal is formed in the first non-display area.

That is, since the liquid crystal is injected into the liquid crystal layer of the first non-display area 301d, it is possible to prevent a depression in the periphery of the transmitting hole 301g of the first non-display area.

Moreover, a refractive index of the liquid crystal is closer to that of a glass than a refractive index of air or a refractive index of vacuum. Therefore, when the liquid crystal is injected into the liquid crystal layer in the first non-display area 301d, diffraction can be prevented from occurring around the transmitting hole. Accordingly, a diffraction pattern can be prevented from being formed on an image that is captured by the camera.

FIG. 4 is a detailed cross section view illustrating a display apparatus according to the second embodiment of the present invention, which illustrates the detail of portion ‘D’ of FIG. 2.

Except the inner structure of the panel, the display apparatus according to the second embodiment of the present invention is identical in structure to the display apparatus according to the first embodiment of the present invention, whereby a detailed explanation for the same parts will be omitted or will be described in brief.

That is, FIG. 4 is a detailed cross section view illustrating the display apparatus according to the second embodiment of the present invention, especially, the detailed cross section view of the panel.

First, the panel includes the upper substrate 301a, the lower substrate 301b, and the liquid crystal layer between the upper substrate 301a and the lower substrate 301b.

The lower substrate 301b in the display apparatus according to the second embodiment of the present invention is identical in structure and manufacturing method to that of the display apparatus according to the first embodiment of the present invention.

Unlike the upper substrate 301a of the display apparatus according to the first embodiment of the present invention, the upper substrate of the display apparatus according to the second embodiment of the present invention is characterized in that column spacers 301h are formed in the first non-display area 301d. In the display apparatus according to the second embodiment of the present invention, a transmitting hole 301g is formed in a black matrix 301k of the first non-display area, and the column spacers 301h are formed in the periphery of the transmitting hole 301g.

To this end, the black matrix, color filter and common electrode are sequentially deposited on the upper substrate 301a, and then the transmitting hole 301g is formed in the black matrix of the first non-display area by the above process. Then, the column spacers 301h are formed in the periphery of the transmitting hole 301g.

Thereafter, the edge of the display area is sealed by a first seal 301e, and then the liquid crystal is injected into the inside of the panel 301 via an inlet under the circumstance that the edge of the display area is sealed. Then, the panel 301 is completed by sealing the inlet.

As shown in FIG. 4, the first seal 301e is formed along the interface between the first non-display area and the display area. In case of the display apparatus according to the first embodiment of the present invention, the liquid crystal is filled in the first non-display area under the circumstance that the seal is not formed between the first non-display area and the display area. In case of the display apparatus according to the second embodiment of the present invention, while the first seal is formed between the first non-display area and the display area, the liquid crystal is injected only into the display area sealed by the first seal.

Also, the edge of the first non-display area is sealed by a second seal 301f, and a cell gap is maintained between the lower substrate 301b and the upper substrate 301a by the use of second seal.

For the manufacturing process of the upper substrate, at least one column spacer is formed in the periphery of the transmitting hole of the first non-display area, whereby the column spacer is formed in the first non-display area sealed by the first and second seals, as shown in FIG. 4.

The column spacer 301h is manufactured by the manufacturing process of the upper substrate. Since various patterns, which are formed at the lower substrate 302b in the display area, are not formed in the first non-display area 301d, it is illustrated that a certain interval between the column spacer 301h and the lower substrate 301b is formed.

The column spacer formed in the display area is deposited in such a manner that a height of the column spacer in the display area is determined in consideration to the height of pattern layers. Also, the column spacer 301h of the first non-display area 301d together with the column spacer of the display area is formed on the upper substrate 301a. Thus, in case of the column spacer 301h provided in the first non-display area on which the pattern for forming the pixel of the lower substrate is not formed, it is formed as a shape being provided at a predetermined interval from the lower substrate. However, the column spacer 301h in the first non-display area may be manufactured separately from the column spacer in the display area. In this case, a height of the column spacer 301h in the first non-display area 301d may be determined in consideration to a height of the cell gap between the lower substrate and the upper substrate, whereby the column spacer 301h in the first non-display area 301d may contact with the lower substrate.

As mentioned above, the various patterns for forming the pixel are not formed in the first non-display area. This is for improving the efficiency of antenna received in an antenna receiving part of the first panel supporter for supporting the first non-display area.

That is, the first panel supporter of the display apparatus according to the present invention may include not only the camera receiving part but also the antenna receiving part at both lateral sides of the camera receiving part. Thus, if receiving the antenna, the various patterns of the metal material for forming the pixel may deteriorate the efficiency of the antenna. In this respect, the various patterns of the display area are not provided in the lower substrate of the first non-display area.

If the patterns of the display area are provided in the lower substrate, an additional transmitting hole for transmitting light to the camera has to be formed in the patterns of the lower substrate. Thus, the patterns for forming the lower substrate are not provided in the first non-display area of the display apparatus according to the present invention. If the patterns of the lower substrate are provided in the first non-display area for the manufacturing process of the lower substrate, the patterns may be removed from the first non-display area by the etching process.

The column spacer in the non-display area is provided at a predetermined gap from the lower substrate. Virtually, the gap between the column spacer and the lower substrate is about 0.77 μm, which is negligible.

Even though the panel of the transmitting hole of the first non-display area is pushed by the external force, the column spacer enables to prevent the depression of the black matrix, thereby preventing the depression of the upper substrate.

Moreover, since depression is prevented, the gap between the upper substrate 301a and the lower substrate 301b is not changed. Therefore, a refractive index between the upper substrate 301a and the lower substrate 301b is not changed. Accordingly, diffraction can be prevented from occurring around the transmitting hole, and thus, a diffraction pattern can be prevented from being formed on an image that is captured by the camera.

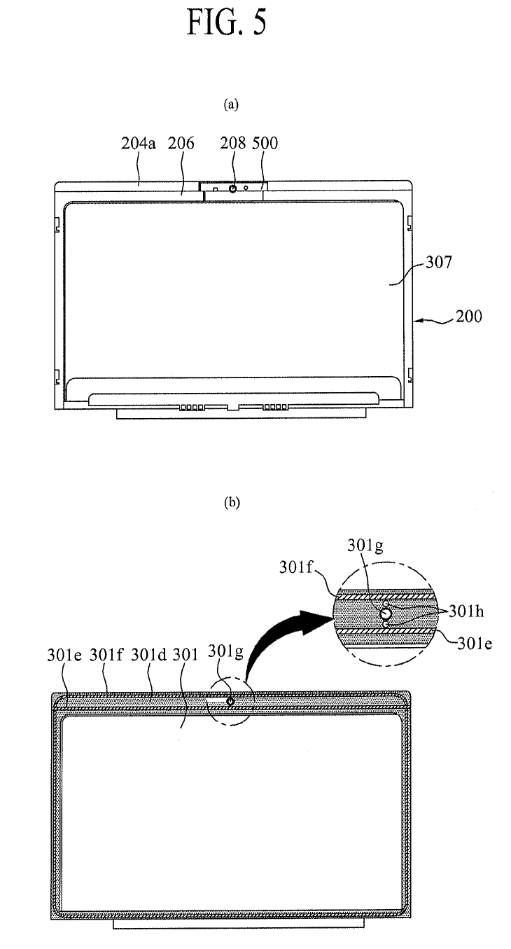

FIG. 5 is a plan view illustrating the lower side of a display apparatus according to the present invention, wherein (a) of FIG. 5 illustrates a virtually-shown lower side of the display apparatus according to the first embodiment and second embodiment, and (b) of FIG. 5 illustrates a perspective view of the panel placed on the panel supporter and the lower supporter, particularly, the first seal 301e and the second seal 301f formed inside the panel of the display apparatus according to the second embodiment of the present invention.

As shown in (a) of FIG. 5, the peripheral region of the lower side of the display apparatus according to the first embodiment and the second embodiment is covered with the guide frame 200.

As mentioned above, the guide frame 200 is formed vertically while being in parallel to the set sidewall 102 of the set cover 100, wherein the guide frame 200 is formed in the square-shaped frame. The guide frame 200 includes the guide sidewall 202 which covers the lateral side of the display unit 300. However, since the guide sidewall 202 protrudes in the opposite direction to the viewing side from (a) of FIG. 5, the guide sidewall 202 is not shown in (a) of FIG. 5.

The panel supporter, which protrudes from the guide sidewall in the opposite direction to the set cover, supports the panel. Especially, the camera hole 208 is formed in the first panel supporter 204a with the camera receiving part 500 to be provided with the camera.

That is, the camera receiving part 500 for receiving the camera therein is formed in the central portion of the first panel supporter 204a. Also, the camera hole 208 is formed in the first panel supporter with the camera receiving part. Thus, the ambient light comes to the camera via the first peripheral portion of the polarizing film, the panel, and the camera hole 208.

The lower supporter 206 is formed with the step height from the panel supporter, and the lower supporter 206 supports the light-guiding plate, the light source, the reflective plate, and the optical film arranged at the lower side of the panel. Herein, since the reflective plate 307 is positioned at the lowest portion as shown in FIG. 2, the reflective plate 307 is placed onto the lower supporter 206, as shown in (a) of FIG. 5.

For the above explanation about the display apparatus according to the present invention, the display apparatus according to the present invention is a liquid crystal display apparatus having the display unit including the light-guiding plate and the light source, but it is not limited to this type. Instead, the display unit may be formed of plasma display panel, a field emission display apparatus, and a light-emitting display apparatus.

Also, (b) of FIG. 5 illustrates the lower side of the display apparatus according to the second embodiment of the present invention. As mentioned above, (b) of FIG. 5 illustrates the perspective view of the panel placed on the panel supporter and the lower supporter 206. Thus, (b) of FIG. 5 illustrates the transmitting hole 301g, first seal 301e, and second seal 301f in the first non-display area inside the panel applied to the second embodiment of the present invention.

That is, the second seal is formed in the outermost portion of the panel, whereby the second seal is formed in the outermost portion of the entire panel. Also, the first seal is formed along the interface between the display area and the first non-display area 301d of the panel.

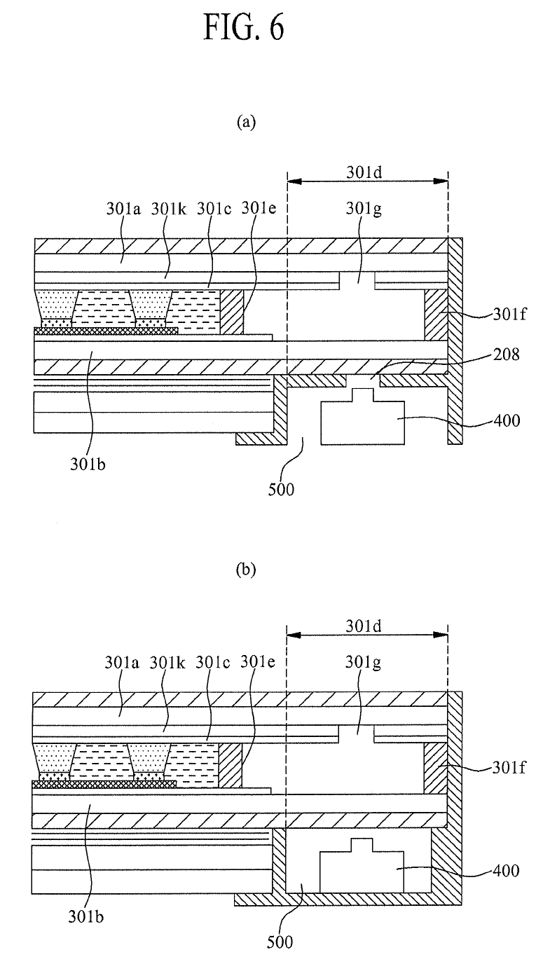

FIG. 6 is a detailed cross section view illustrating a display apparatus according to the third embodiment of the present invention, which illustrates the detail of portion D′ of FIG. 2.

Except that the first seal 301e is formed to separate the display area and the first non-display area of the panel from each other, and the first non-display area is not filled with liquid crystal, the display apparatus according to the third embodiment of the present invention is identical in structure to the display apparatus according to the first embodiment of the present invention. Also, except that the column spacer is not formed in the first non-display area, the display apparatus according to the third embodiment of the present invention is identical in structure to the display apparatus according to the second embodiment of the present invention. Thus, a detailed explanation for the same parts as those of the first or second embodiment will be omitted. Also, even though the guide frame shown in (a) of FIG. 6 is different in structure from the guide frame shown in (b) of FIG. 6, their functions are the same.

First, in comparison to the first embodiment of the present invention, (a) of FIG. 6 shows that the first non-display area 301d and the display area are sealed by the first seal 301e, and the liquid crystal is not filled in the first non-display area 301d sealed by the first seal 301e and the second seal 301f.

In comparison to the second embodiment of the present invention, (a) of FIG. 6 shows that the column spacer is not formed in the first non-display area.

Except that the structure of the first panel supporter with the camera receiving part, (b) of FIG. 6 is identical in structure and function to (a) of FIG. 6.

As mentioned in the above explanation for the first embodiment of the present invention with reference to FIG. 2, the first panel supporter 204a may be formed in the ‘n’ shape or ‘u’ shape. In this case, (a) of FIG. 6 illustrates the ‘n’-shaped first panel supporter, and (b) of FIG. 6 illustrates the V-shaped first panel supporter.

The third embodiment of the present invention enables to prevent a ripple phenomenon from occurring in the panel by the contact with the first panel supporter.

The third embodiment shown in (a) and (b) of FIG. 6 enables to prevent a ripple phenomenon from occurring by the interference with the guide frame arranged in the lower side of the panel.

In addition, among the black matrixes deposited on the upper substrate, the non-display area including the periphery of the transmitting hole in the area corresponding to the camera is isolated by the first seal 301e, and the liquid crystal is not filled in the non-display area 301d, whereby it is possible to prevent a ripple phenomenon from occurring in the panel by the first panel supporter, wherein the first panel supporter supports the panel while being positioned at the lower side of the panel.

If the first panel supporter is formed in the ‘∪’ shape, as shown in (b) of FIG. 6, the above function may be maximized. That is, in (b) of FIG. 6, the first panel supporter 204a is formed in the ‘∪’ shape, and thus, the first non-display area including the periphery of the transmitting hole is not attached to the first panel supporter 204a. Therefore, interference between the first non-display area and the first panel supporter 204a does not occur. Accordingly, a ripple is not generated.

In the third embodiment of the present invention, the first seal 301e and the second seal 301f surround the first non-display area. However, a portion of the second seal 301f may be opened. In this case, the first non-display area may be maintained at the atmospheric pressure condition. Therefore, in the non-display area of the panel, a space in which the transmitting hole is formed to correspond to the camera may maintained at the atmospheric pressure condition.

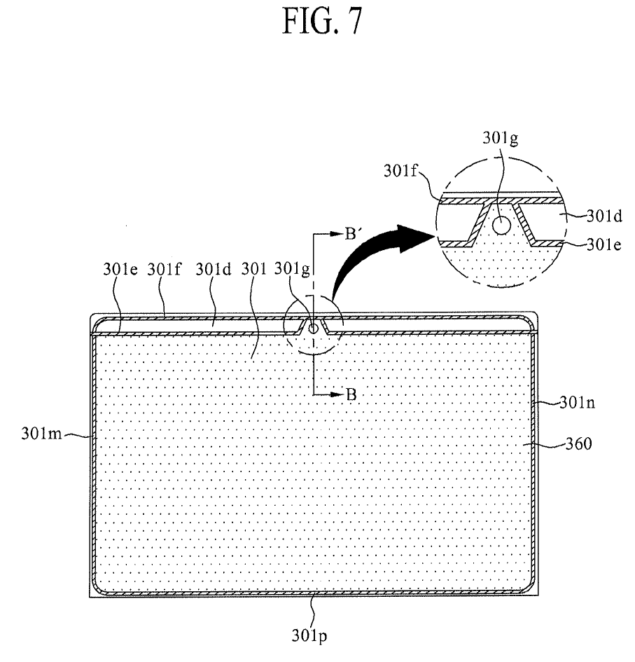

Hereinafter, a display apparatus according to the fourth embodiment of the present invention will be described with reference to FIGS. 7 to 16

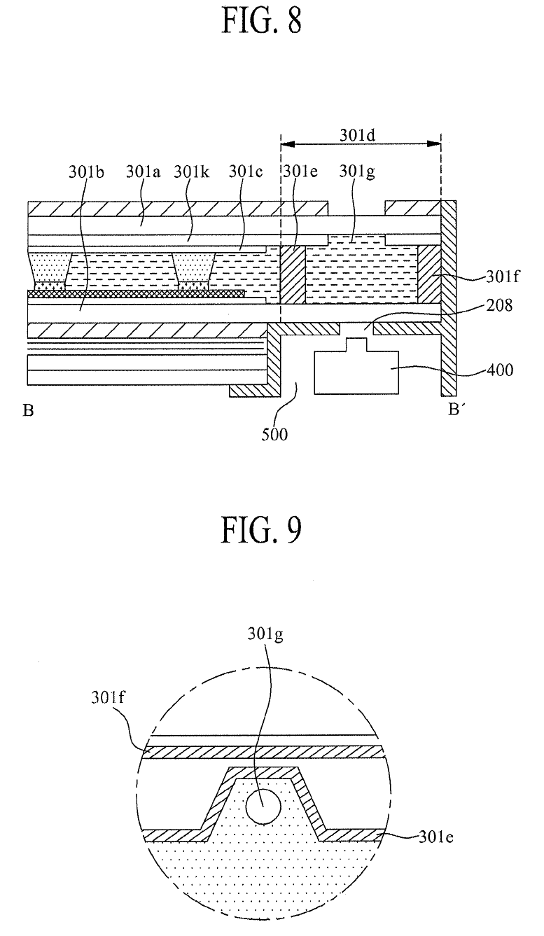

FIG. 7 is a plan view illustrating a panel applied to a display apparatus according to the fourth embodiment of the present invention, which illustrates the plane of the panel 301 of the display apparatus shown in FIG. 2. FIG. 8 is a detailed sectional view illustrating a first seal formed in a panel of the display apparatus according to the fourth embodiment of the present invention, which illustrates the detail of portion ‘D’ of FIG. 2. Especially, the cross section of the panel 301 shown in FIG. 8 is to the cross section along B-B′ of FIG. 7.

The panel applied to the display apparatus according to the fourth embodiment of the present invention includes the upper substrate 301a and the lower substrate 301b which are bonded to each other under the circumstance that the liquid crystal layer is formed therebetween. The liquid crystal layer between the lower substrate 301b and the upper substrate 301a is sealed by the seal formed in the peripheral region of the panel.

The panel applied to the present invention may be divided into the display area 360 in which the various elements are formed to display the image; and the non-display area which is formed in the periphery of the display area. At this time, the second to fifth seals 301f, 301m, 301n, 301p are respectively formed at the peripheral regions of the panel in the non-display area of the panel, thereby sealing the gap between the upper substrate and the lower substrate. Also, the first seal 301e is formed between the first non-display area 301d and the display area 360.

That is, the second to fifth seals 301f, 301m, 301n, 301p are formed in the outermost portions of the four sides of the panel, that is, the outermost portions of the entire panel. The first seal 301e is formed in the boundary between the first non-display area 301d of the panel and the display area 360.

Also, in order to make the ambient light guide toward the camera lens, the transmitting hole 301g made by removing the black matrix 301k is formed in the first non-display area 301d.

As shown in the expanded circle portion of FIG. 7, the first seal 301e is formed in the shape surrounding the transmitting hole and the peripheral region of the transmitting hole (hereinafter, referred to as ‘transmitting part’). In FIG. 7, since the first seal and second seal surrounding the transmitting part are connected with each other, the transmitting part is isolated from the remaining portions of the first non-display area except the transmitting part (which will be referred to as ‘vacuum part’), and is provided to penetrate the display area.

When the liquid crystal (liquid crystal layer) is filled between the lower subtrate and the upper substrate sealed by the first seal 301e and the third to fifth seals 301m, 301n, 301p, the liquid crystal is filled in the transmitting part. At this time, the vacuum part is sealed by the first seal and the second seal under the vacuum state.

The above structure can be shown in FIG. 8 which illustrates the cross section of the display apparatus according to the fourth embodiment of the present invention. The cross section shown in FIG. 8 illustrates the display apparatus according to the present invention on which the panel including the cross section along B-B′ of FIG. 7 is mounted, especially, the cross section of portion D′ of FIG. 2.

That is, as shown in FIGS. 7 and 8, the panel applied to the present invention includes the upper substrate 301a, the lower substrate 301b, and the liquid crystal layer formed between the upper substrate 301a and the lower substrate 301b.

The upper substrate 301a, lower substrate 301b, and liquid crystal layer is the same as those of the above, whereby a detailed explanation for the upper substrate 301a, lower substrate 301b, and liquid crystal layer will be omitted.

In FIGS. 7 and 8, the second seal 301f indicates the seal formed in the outermost portion of the first non-display area 301d of the panel; and the first seal 301e indicates the seal formed along the interface between the display area 360 of the panel and the first non-display area 301d.

As shown in FIG. 7, the first seal 301e is extended from the third seal 301m and the fourth seal 301n while being in parallel to the second seal 301f; curved toward the second seal to surround the transmitting part, and then connected with the second seal. Meanwhile, since FIG. 8 illustrates the cross section surface along B-B′ of FIG. 7, the first seal 301e is expressed by a dotted line.

As mentioned above, since the transmitting part is sealed by the first seal and the portions of the second seal, the liquid crystal is filled therein, and the vacuum part of the first non-display area except the transmitting part is sealed under the vacuum state by the use of first seal and second seal.

The reason why the transmitting part is filled with the liquid crystal is to compensate for a concentric-circle shaped diffraction pattern in accordance with diffraction of light passing through the transmitting hole 301g by using a scattering property of liquid crystal.

That is, the concentric-circle shaped diffraction pattern on the image taken by the camera, and the spectrum mura shown on the external of the panel may occur due to the diffraction of light passing through the transmitting hole. These problems are solved through the use of scattering property of liquid crystal by filling the liquid crystal in the transmitting part between the transmitting hole and the camera lens.

Especially, since a refractive index (n=1.54) of the liquid crystal is similar to a refractive index (n=1.51) of glass for forming the lower substrate and the upper substrate, the diffraction may be decreased more, thereby resulting in the decreased diffraction pattern on the image and the decreased spectrum mura on the front of the panel.

In addition to the shapes shown in FIGS. 7 and 8, the various shapes of first seal surrounding the transmitting part may be provided.

FIGS. 9 to 13 are various exemplary views illustrating a first seal formed in a panel of the display apparatus according to the fourth embodiment of the present invention, which illustrate various examples of the seal pattern in the periphery of the transmitting part, and correspond to the expanded circle shape of FIG. 3.

First, the first seal 301e shown in FIG. 9 is extended from the third seal and the fourth seal while being in parallel to the second seal, wherein the first seal 301e is formed in the shape surrounding the transmitting part.

That is, the transmitting part shown in FIG. 7 is surrounded by the first seal and the portions of the second seal. Meanwhile, the transmitting part shown in FIG. 9 is surrounded only by the first seal 301e.

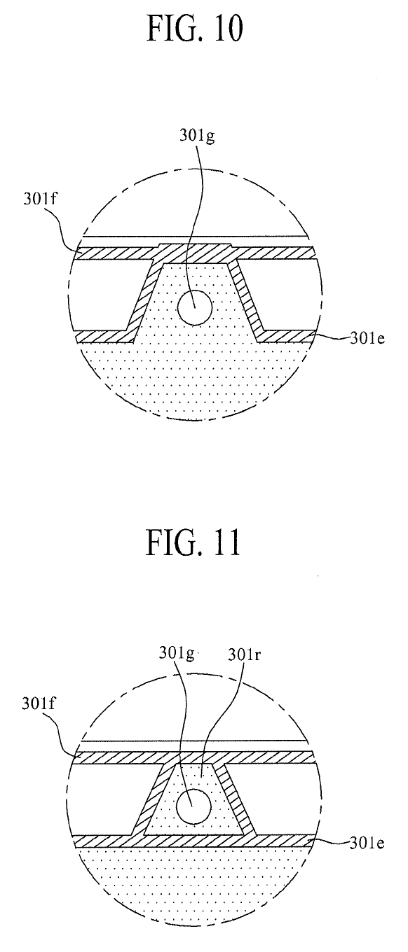

Then, the first seal shown in FIG. 10 extends from the third seal and the fourth seal while being in parallel to the second seal, and then surrounds the transmitting part. In this case, the first seal 301e being positioned adjacent to the second seal 301f is overlapped with the second seal 301f.

That is, in case of the transmitting part shown in FIG. 7, one side of the transmitting part is surrounded only by the second seal. In case of the transmitting part shown in FIG. 10, the transmitting part is surrounded by the first seal, wherein the predetermined portion of the first seal 301e being adjacent to the second seal 301f overlaps with the second seal 301f.

Then, the first seal shown in FIG. 11 is identical in structure to the first seal shown in FIG. 7. Additionally, the first seal is formed between the transmitting part and the display area.

That is, the transmitting part shown in FIG. 11 is isolated from the display area and the vacuum part by the first seal 301e and the predetermined portion of the second seal 301f.

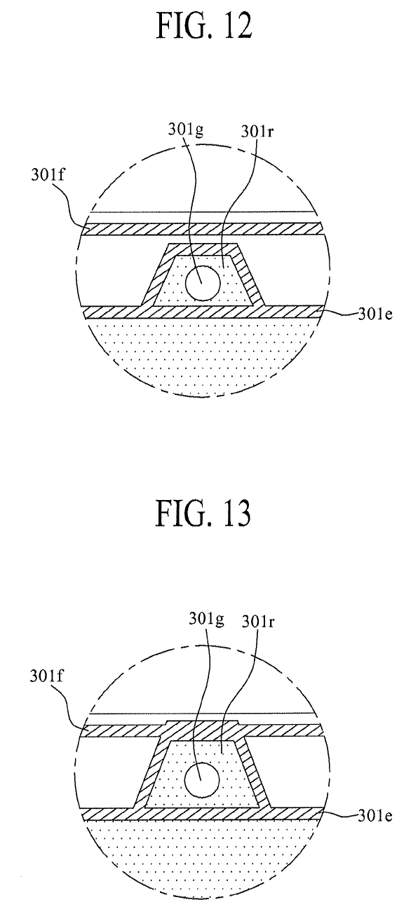

Then, the first seal shown in FIG. 12 is identical in structure to the first seal shown in FIG. 9. Additionally, the first seal is formed between the transmitting part and the display area.

That is, the transmitting part shown in FIG. 12 is isolated from the display area and the vacuum part by the first seal.

Then, the first seal shown in FIG. 13 is identical in structure to the first seal shown in FIG. 10. Additionally, the first seal is formed between the transmitting part and the display area.

That is, the transmitting part shown in FIG. 13 is isolated from the display area and the vacuum part by the first seal 301e, and the overlapped portion between the first seal 301e and the second seal 301f.

Among the above-described elements, the transmitting part passes through the display area by the first seal shown in FIGS. 7 to 10. Thus, in case of the panel shown in FIGS. 7 to 10, the transmitting part may be filled only with the liquid crystal.

However, the transmitting part is isolated from the display area and the vacuum part while being sealed by the first seal shown in FIGS. 11 to 13. Thus, in case of the panel shown in FIGS. 11 to 13, the transmitting part may be filled with the other filling materials in addition to the liquid crystal.

First, the transmitting part of the panel shown in FIGS. 11 to 13 may be filled with the filling material of the liquid crystal. In the same manner as the liquid crystal injection method, an inlet is formed in the first seal surrounding the transmitting part, and then liquid crystal is injected via the inlet and the inlet is sealed.

In this case, it is possible to prevent the foreign matters from being collected in the transmitting part. That is, if the liquid crystal is injected into the panel shown in FIGS. 7 to 10, the foreign matters remaining between the lower substrate and the upper substrate may be collected in the transmitting part, thereby deteriorating the light transmittance. In case of the panel shown in FIGS. 11 to 13, the transmitting part is separately sealed so that this problem does not occur.

Then, the transmitting part of the panel shown in FIGS. 11 to 13 may be filled with liquid or gas whose refractive index is similar to that of glass for forming the upper substrate and the lower substrate.

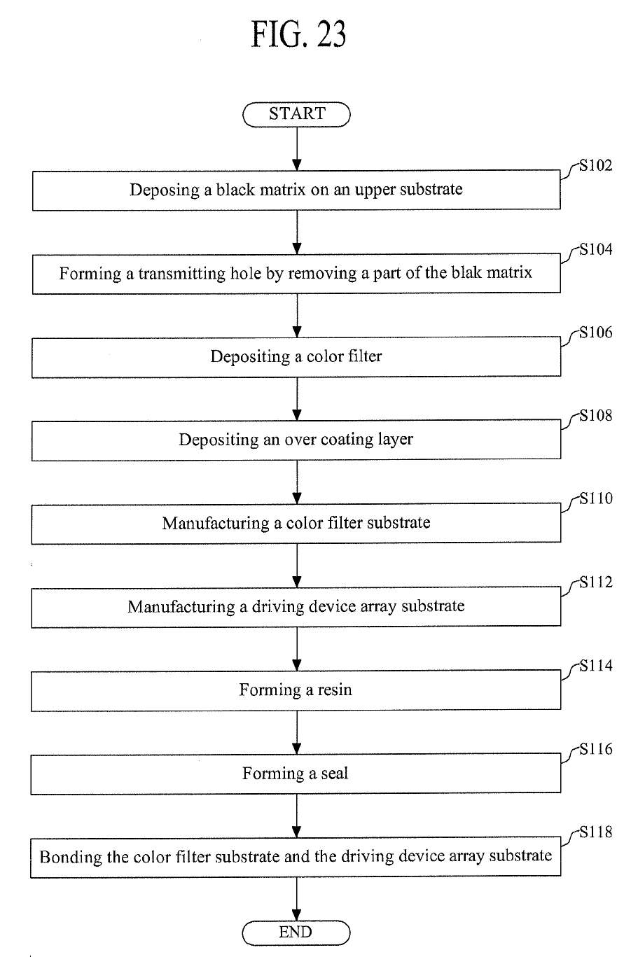

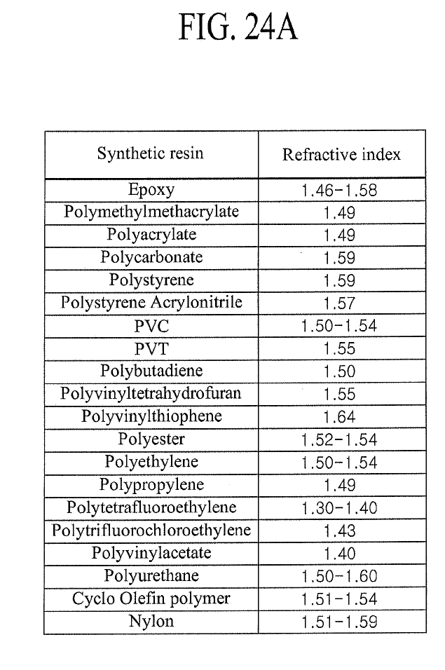

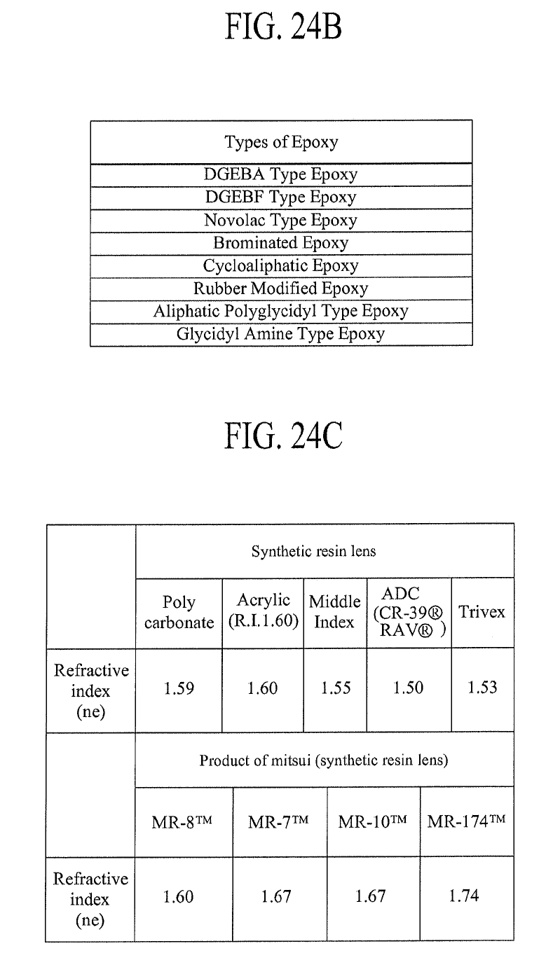

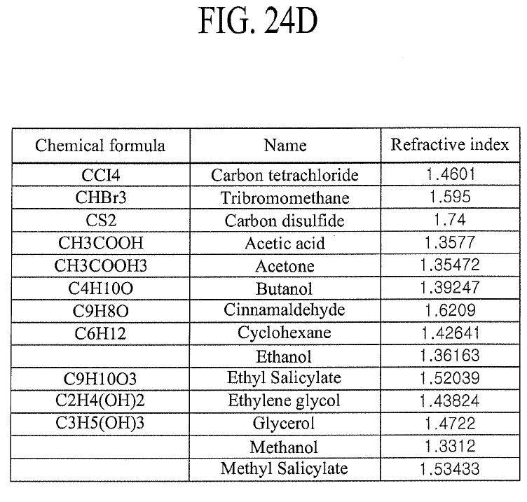

The refractive index of glass is about 1.51. As shown in the following Table 1, the transmitting part may be filled with various liquid, gas or solid materials (which will be referred to as ‘the filling material’) 301r whose refractive index is similar to 1.51. Additional explanation about the material configuring the filling material will be explained as follows with reference to FIGS. 23 to 24.

TABLE 1

| Material | Refractive index |
|---|---|
| Ethyl Salicylate | 1.52 |
| Styrene | 1.52 |
| Methyl Salicylate | 1.53 |
| Sugared Water (80%) | 1.49 |

If the filling material 301r is the liquid or gas material, in the same manner as the liquid crystal injection method, an inlet is formed in the first seal for forming the transmitting part, and then liquid or gas filling material is injected via the inlet and the inlet is sealed.

If the filing material is a solid material, the filling material manufactured in the same shape as that of the transmitting part may be positioned in the transmitting part. Unlike the liquid crystal layer, it is unnecessary to completely seal the transmitting part by the first seal. That is, after injecting the solid filling material by forming an inlet in the first seal for forming the transmitting part, the first seal of the transmitting part may be sealed.

That is, as mentioned above, the method for injecting the liquid, solid, or gas filling material into the transmitting part sealed by the first seal is to minimize the refraction of light passing through the transmitting part by the use of filling material whose refractive index is very similar to that of glass, thereby resulting in the minimized light diffraction. Thus, it is possible to improve visibility by decreasing the spectrum mura on the panel surface, and to remove the concentric-circle shaped diffraction pattern from the image taken by the camera.

Preferably, the refractive index of the above filling material 301r is about 1.3 to about 1.7 in consideration to the diffraction property.

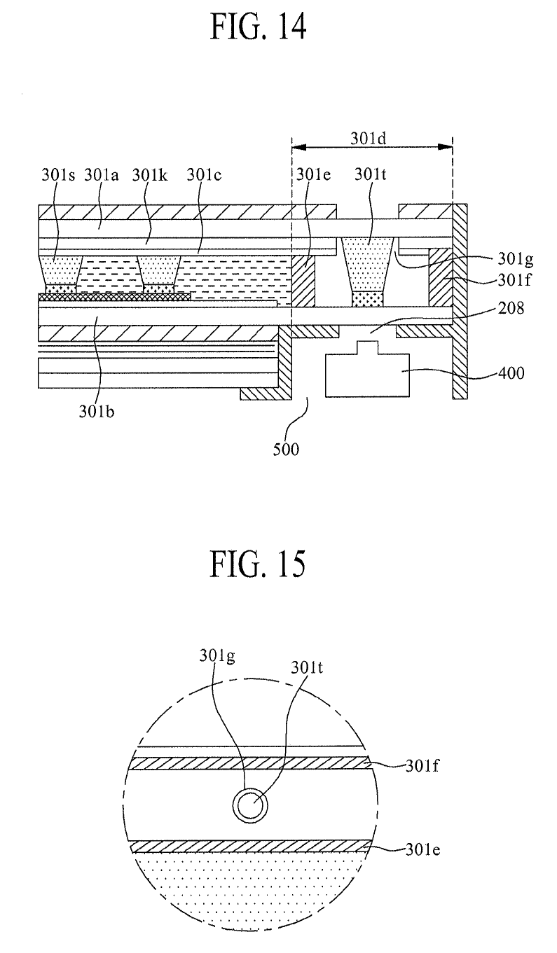

FIG. 14 is another detailed sectional view illustrating the display apparatus according to the fourth embodiment of the present invention, which illustrates the detail of portion ‘D’ of FIG. 2. FIG. 15 is another plan view illustrating a panel applied to the display apparatus according to the fourth embodiment of the present invention. The first non-display area of FIG. 14 is exemplary shown in FIGS. 9 to 13.

As shown in FIG. 14, another shape of the display apparatus according to the present invention includes the first seal 301e which is provided for the division between the display area 360 of the panel and the first non-display area 301d. If the first non-display area is not filled with the liquid crystal (vacuum state), a transmitting-hole column spacer 301t whose structure is the same as that of a column spacer 301s in the display area is formed in the transmitting hole 301g made by removing the black matrix 301k.

Herein, the transmitting-hole column spacer 301t may be the solid filling material that has been described above with reference to FIGS. 11 to 13. That is, the transmitting-hole column spacer 301t is formed of a material having a refractive index similar to that of the glass, and thus removes a spectrum-shaped concentric circle by decreasing the diffraction of light passing through the transmitting hole. The material forming the transmitting-hole column spacer 301t will be additionally described below with reference to FIGS. 23 to 24.

The transmitting-hole column spacer 301t may be manufactured together with the column spacer 301s formed in the display area. In this case, as a height of the transmitting-hole column spacer 301t becomes higher than a height of the column spacer in the display area by the use of halftone mask, the transmitting-hole column spacer may contact with the upper substrate and the lower substrate. However, since there is the small gap between the upper substrate and the lower substrate, it is allowed that the transmitting-hole column spacer is formed at the same height as that of the column spacer in the display area by the same process

As shown in FIG. 15, under the circumstance that the peripheral region of the transmitting hole is not surrounded by the first seal, the transmitting-hole column spacer is formed in the transmitting part. As shown in FIGS. 7 to 11, the transmitting-hole column spacer formed in the transmitting part may vary in shape.

That is, as shown in FIGS. 7 to 10, the transmitting-hole column spacer 301t may be surrounded by the first seal under the circumstance that the transmitting part penetrates through the display area. As shown in FIGS. 11 to 13, the transmitting-hole column spacer may be isolated from the display area and the vacuum part while being sealed.

Thus, if the transmitting-hole column spacer is formed in the transmitting part as shown in FIGS. 7 to 10, the transmitting part is filled with the liquid crystal.

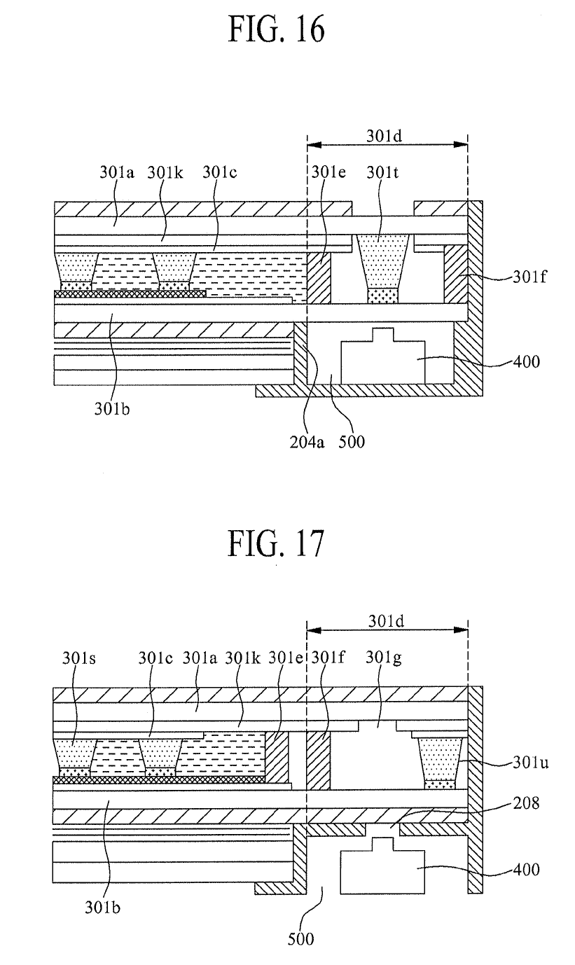

FIG. 16 is another detailed sectional view illustrating the display apparatus according to the fourth embodiment of the present invention. Except the structure of first panel supporter 204a, the display apparatus shown in FIG. 16 is identical in structure to the display apparatus shown in FIGS. 7 to 15, whereby a detailed explanation for the same part will be omitted.

Except the structure of the first panel supporter 204a having the camera receiving part, the display apparatus shown in FIG. 16 is identical in structure and function to the display apparatus shown in FIGS. 7 to 15.

That is, as mentioned in the above explanation with reference to FIG. 2, the first panel supporter 204a may be formed in the ‘∩’ shape or ‘∪’shape. FIG. 16 illustrates the ‘∪’-shaped first panel supporter.

Thus, except the first panel supporter, the display apparatus shown in FIG. 16 is identical in structure to the display apparatus shown in FIGS. 7 to 15, wherein the transmitting part may vary in shape, as mentioned above.

That is, in the display apparatus according to the fourth embodiment of the present invention, the transmitting part inside the panel 301 is filled with various filling materials or the transmitting-hole column spacer 301t is formed in the transmitting part, thereby decreasing the diffraction pattern on the image taken by the camera, and the spectrum mura shown on the plane of the panel. The structure of the transmitting part may be manufactured in various shapes, as mentioned above.

In addition, since the transmitting hole generates the concentric-circle shaped diffraction pattern by the diffraction of light, the spectra mura to be shown by the naked eyes occurs in the periphery of the transmitting hole, and the concentric-circle shaped diffraction pattern is shown on the image taken by the camera. In case of the display apparatus according to the fourth embodiment of the present invention, the transmitting part is sealed by the use of seal, and is then filled with the various kinds of the filling material, thereby preventing the above diffraction phenomenon. Thus, it is possible to remove the spectra mura shown by the naked eyes, and to remove the diffraction pattern from the image taken by the camera.

For this, the display apparatus according to the fourth embodiment of the present invention uses the following two methods.

The first method is to scatter the light passing through the transmitting hole and advancing toward the camera lens by filling the transmitting part with the filling material having the scattering property, for example, the liquid crystal.

The second method is to decrease the refraction and diffraction of the light passing through the transmitting hole and advancing toward the camera by filling the transmitting part with the solid, liquid, or gas filling material whose refractive index is similar to that of the glass for forming the panel. In case of the solid material, it is possible to apply the transmitting-hole column spacer whose shape is the same as that of the column spacer for maintaining the cell gap between the upper substrate and the lower substrate. The liquid glass material may be injected into the transmitting part, and be coagulated therein. Also, the solid glass material may be attached to the transmitting part.

For filling the transmitting part with the various kinds of filling material in the display apparatus according to the fourth embodiment of the present invention, the peripheral region of the transmitting part may be sealed in various shapes by the use of seal.

In the display apparatus according to the fourth embodiment of the present invention, the depression is not generated in the periphery of the transmitting part since the peripheral region of the transmitting hole is surrounded by the seal, or filled with the filling material, thereby preventing the mura defect from the predetermined portion of the display area being adjacent to the transmitting hole.

The third method is a method that forms the transmitting-hole column spacer 301t in the transmitting part which is not surrounded by a seal.

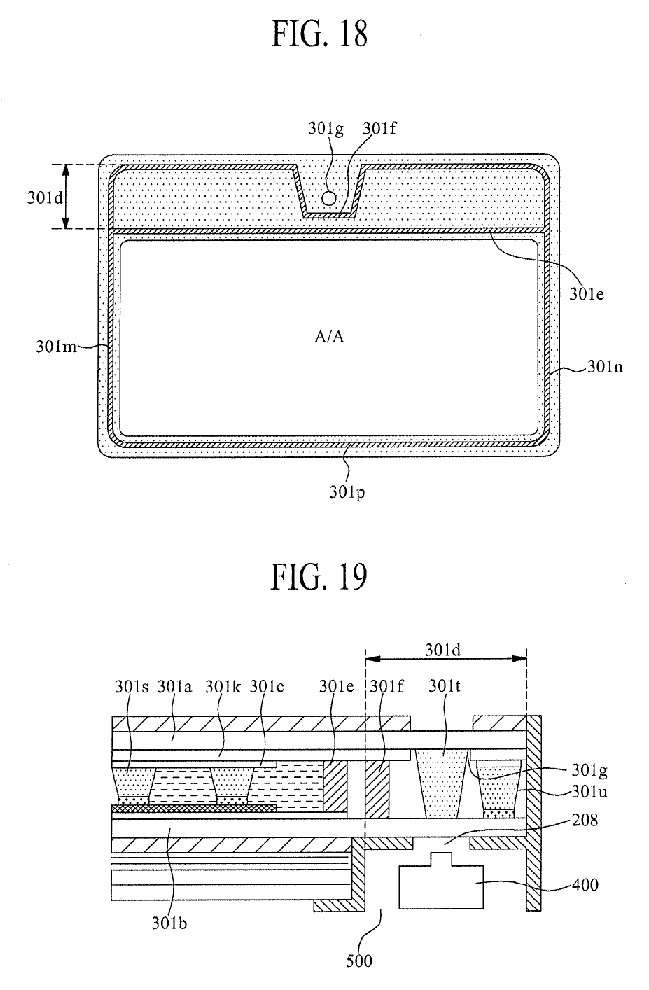

FIG. 17 is a detailed sectional view illustrating a display apparatus according to the fifth embodiment of the present invention, which illustrates the detail of portion ‘D’ of FIG. 2. FIG. 18 is an exemplary view illustrating a plane of the display apparatus according to the fifth embodiment of the present invention illustrated in FIG. 17, which illustrates the first seal 301e and third to fifth seals 301m to 301p formed in a periphery of the display area (A/A), and the second seal 301f formed in the non-display area. In the following description, a description equal or similar to that of FIGS. 1 to 16 is not provided or will be simply made.

A column spacer 301s formed between the upper substrate and the lower substrate may be formed by using a transparent resin-like substance or the like. Since it is difficult to accurately match a length of the column spacer 301s with a cell gap, as shown in FIG. 17, a material such as a pigment or metal may be added to a position which is under the column spacer 301s. After the pigment or metal is formed in the lower substrate, and the column spacer is formed in the upper substrate, the upper substrate and the lower substrate are bonded to each other, whereby the two materials are combined to maintain the cell gap. That is, the protrusion corresponding to the column spacer 301s may be formed in the lower substrate and the protrusion prevents a press defect when the column spacer contacts with the lower substrate. Hereinafter, the column spacer 301s may mean the column spacer itself or mean another meaning which includes the column spacer and the material like the pigment or metal. This may be applied to the column spacer explained in the embodiments described above with reference to FIG. 1 to FIG. 16.

The non-display area of the panel, especially, the periphery of the first non-display area is sealed by the second seal 301f, and therefore, the cell gap between the upper substrate and the lower substrate may be maintained.

The second seal 301f, as shown in FIG. 18, is formed not to cover the transmitting hole 301g. The second seal 301f surrounds the periphery of the transmitting hole 301g, and a process of forming the second seal 301f is performed in a vacuum. Therefore, the display area (A/A), which is surrounded by the first seal 301e and the third to fifth seal 301m to 301p, and a portion of the first non-display area, which is surrounded with the second seal 301f, are maintained in a vacuum state, but the transmitting part, which is not surrounded with the first seal 301e and the second seal 301f in the first non-display area, is maintained in the atmospheric pressure condition. Herein, the transmitting part means the vertical space between the upper substrate, in which the transmitting hole 301g is formed, and the lower substrate which is adjacent to the camera hole 208 or a camera lens. The transmitting part includes a space such as a cylinder, a diameter of which is bigger than a diameter of the transmitting hole 301g or is the same as the diameter of the transmitting hole. That is, the transmitting part includes a space in which the transmitting hole is formed, and another space which is adjacent to the transmitting hole in the periphery spaces of the transmitting hole. Therefore, the first non-display area may be divided into three portions. Herein, one part is a part in which the transmitting hole is formed, another part is a periphery of the transmitting hole which surrounds the transmitting hole and adjacent to the transmitting hole, and the other part is a faraway region from the transmitting hole. The transmitting part includes a part in which the transmitting hole is formed, and the periphery of the transmitting hole. Therefore, the transmitting part has an area larger than that of the transmitting hole. This may be applied to the transmitting hole explained above with reference to FIG. 1 to FIG. 16.

The present invention maintains a portion of the first non-display area, in which the transmitting part is formed, in the vacuum state, and thus preventing a substrate in the periphery of the transmitting hole 301g or camera hole 208 from bending to decrease the spectrum mura in the periphery the transmitting hole 301g or camera hole 208.

In addition, in the fifth embodiment of the present invention, since the space between the transmitting hole 301g and the camera hole 208 is maintained in the vacuum state, the upper substrate 301a and the lower substrate 301b are not pushed therebetween. Therefore, the upper substrate 301a and the lower substrate 301b does not bend and the spectrum mura does not occur in the periphery of the transmitting hole 301g or camera hole 208.

Although not shown in FIG. 17 and FIG. 18, the column spacer 301u also may be formed in the periphery of the transmitting part at the atmospheric pressure condition, as shown in FIG. 19, in order to maintain the gap between the upper substrate and the lower substrate.

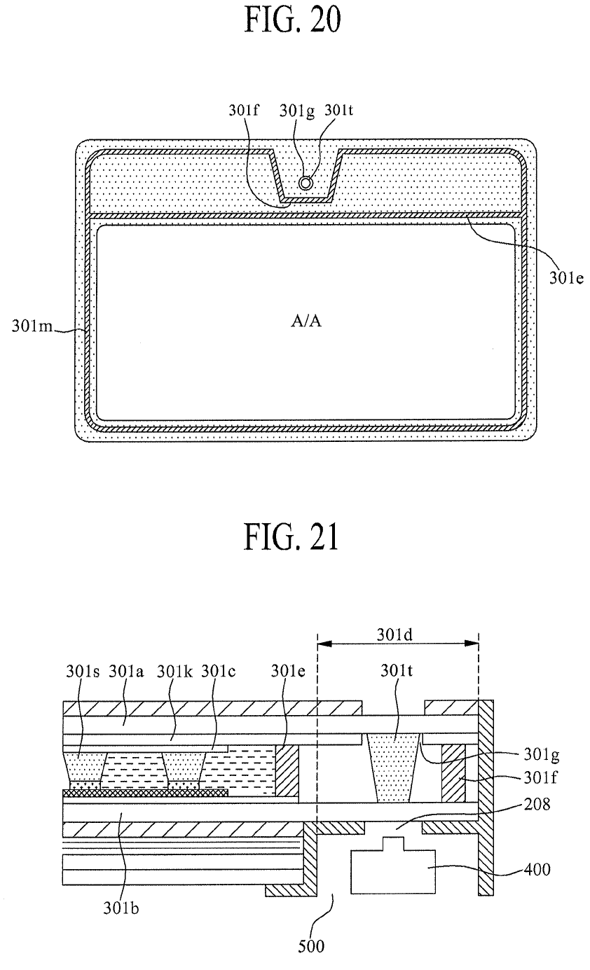

FIG. 19 is another detailed sectional view illustrating the display apparatus according to the fifth embodiment of the present invention, which illustrates the detail of portion D′ of FIG. 2. FIG. 20 is an exemplary view illustrating a plane of the display apparatus according to the fifth embodiment of the present invention illustrated in FIG. 19, which illustrates the first seal 301e, a third seal 301m, a fourth seal and a fifth seal formed in a periphery of the display area (A/A), and the second seal 301f formed in the first non-display area.

Except a transmitting material that is added to the transmitting part in the first non-display area, the display apparatus of FIG. 19 and FIG. 20 is identical to the display apparatus of FIG. 17 and FIG. 18 in structure, and therefore, a repetitive description is not provided or will be simply made.

According to the features of the display apparatus of FIG. 19 and FIG. 20, in the space that is formed between the upper substrate 301a and the lower substrate 301b, the solid transmitting material 301t is formed in a space (the transmitting part) between the transmitting hole 301g and the camera hole 208 that is maintained at the atmospheric pressure condition.

The transmitting material 301t may be formed after the column spacer 301s, 301u are formed in the display area or the first non-display area, or the transmitting material 301t and the column spacer may be formed at the same time.

The transmitting material 301t is formed of a material having a refractive index similar to that of the glass which configures the upper substrate and the lower substrate, and thus, removes a spectrum-shaped concentric circle by decreasing the diffraction of light passing through the transmitting hole.

Although glass is used as the transmitting material 301t, materials different from glass may be used as the transmitting material 301t. That is, a transparent material having a refractive index similar to that of the glass which configures the upper substrate and the lower substrate may be used as the transmitting material 301t. Therefore, the transmitting material 301t may be formed of a resin-based transparent material forming the column spacer 301s, wherein the transmitting material 301t and the column spacer may be formed at the same time.

The transmitting material 301t may be formed by a deposition process. However, another method may be used, which manufactures the transmitting material in a separate process by considering the shape of the transmitting hole 301g and the gap between the upper substrate and the lower substrate to places the transmitting material on the transmitting part. That is, since a part of the first non-display area, in which the transmitting part is formed, is exposed to the outside in the atmospheric pressure condition, it is possible to place the transmitting material 301t, which is manufactured in the separate process, on the space between the transmitting hole 301t and the camera hole 208 to fix the transmitting material 301t to the transmitting hole and the camera hole by using a glue.

The present invention described above minimizes the refraction of light passing through the transmitting hole 301g by the use of the transmitting material whose refractive index is very similar to that of glass, thereby resulting in the minimized light diffraction. Thus, it is possible to improve visibility by decreasing the spectrum mura on the panel surface, and to remove the concentric-circle shaped diffraction pattern from the image taken by the camera.

Preferably, the refractive index of the above the transmitting material 301t is about 1.3 to about 1.7 in consideration to the diffraction property. The transmitting material 301t may be formed of a material forming the column spacer, and the transmitting material and the column spacer may be formed of the same type. A material forming the transmitting material 301t will be additionally described below with reference to FIGS. 23 to 24.

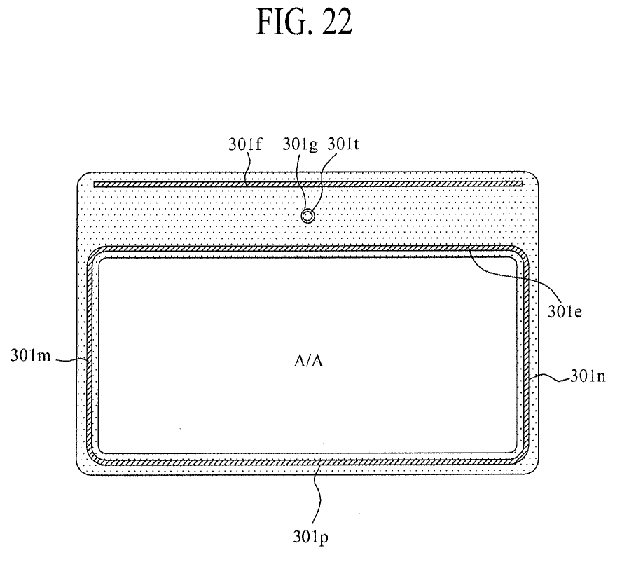

FIG. 21 is another detailed sectional view illustrating the display apparatus according to the fifth embodiment of the present invention, which illustrates the detail of portion ‘D’ of FIG. 2. FIG. 22 is an exemplary view illustrating a plane of the display apparatus according to the fifth embodiment of the present invention illustrated in FIG. 21, which illustrates the first seal 301e and a third seal to a fifth seal 301m, 301n, 301p formed in a periphery of the display area (A/A), and the second seal 301f formed in the first non-display area.

Except a shape of the second seal 301f formed in the first non-display area, the display apparatus of FIG. 21 and FIG. 22 is identical in structure to the display apparatus of FIG. 19 and FIG. 20, and therefore, a description equal or similar to that described above is not provided or will be simply made.

First, all of the display apparatus of FIG. 19 and FIG. 20, and the display apparatus of FIG. 21 and FIG. 22 include the transmitting part in which the transmitting material 301t is placed. Herein, the transmitting part is formed between the transmitting hole and the camera hole. Also, the transmitting material 301t is formed in a space between the transmitting hole 301g and the camera hole 208, the space is formed between the upper substrate 301a and the lower substrate 301b, the space is maintained at the atmospheric pressure condition, and the transmitting material is solid. The present invention of FIG. 21 and FIG. 22 minimizes the refraction of light passing through the transmitting hole 301g by the use of the transmitting material 301t whose refractive index is very similar to that of glass, thereby resulting in the minimized light diffraction. Thus, it is possible to improve visibility by decreasing the spectrum mura on the panel surface, and to remove the concentric-circle shaped diffraction pattern from the image taken by the camera. The material forming the transmitting material 301t will be additionally described below with reference to FIGS. 23 to 24.

Second, in the display apparatus of FIG. 19 and FIG. 20, the second seal 301f surrounds the first non-display area except the periphery of the transmitting part. On the other hand, in the display apparatus of FIG. 21 and FIG. 22, the second seal 301f is only formed on the opposite side of the display area (A/A) in the first non-display area, wherein the transmitting hole 301g is formed between the display area (A/A) and the second seal 301f.

That is, in the display of FIG. 17 to FIG. 20, the second seal 301f is connected to the first seal 301e. In this state, the second seal 301f surrounds a portion of the first non-display area other than the periphery of the transmitting part to form a sealed space. However, in the display apparatus of FIG. 21 and FIG. 22, the second seal 301f completely separates from the first seal 301e.

In addition, in the display of FIG. 17 and FIG. 20, the first non-display area 301d except the periphery of the transmitting part is surrounded by the second seal 301f and the first seal 301e to be maintained in a vacuum state, and only the periphery of the transmitting part is exposed to the outside in the atmospheric pressure condition. However, in the display of FIG. 21 and FIG. 22, since the second seal 301f is only formed on the opposite side of the display area (A/A) in the first non-display area, wherein the transmitting hole 301g is formed between the display area (A/A) and the second seal 301f, all of the first non-display area is exposed to the outside in the atmospheric pressure condition.

In the display apparatus of FIG. 21 and FIG. 22, since the all of the first non-display area 301d including the periphery of the transmitting part are expose to the outside in the atmospheric pressure condition, the upper substrate and the lower substrate can not be recessed in a direction facing each other. Also, since the transmitting material 301t, which has a refractive index similar to that of the glass which configures the upper substrate and the lower substrate, is formed between the transmitting hole and the camera hole, spectrum mura may be prevented from occurring around the transmitting hole. Accordingly, a concentric-circle shaped spectrum mura may be prevented from being formed on an image taken by the camera.

The display apparatus of FIG. 21 and FIG. 22 includes the transmitting material 301t. However, the display apparatus of FIG. 21 and FIG. 22 may not include the transmitting material 301t.

That is, in the display of FIG. 17 and FIG. 18, the second seal 301f may be formed in a shape that is as shown in FIG. 22.

A shape of the first panel supporter applied to the present invention described above with reference to FIG. 17 to FIG. 22 may be changed to the shape of the first panel supporter 204a shown in FIG. 16.

The display apparatus according to the present invention that has been described above with reference to FIGS. 17 to FIG. 22 prevents the spectrum mura from occurring around the transmitting hole 301g or the camera hole 208.

In a borderless type display apparatus according to the related art, the transmitting hole 301g is formed by removing a predetermined portion of the black matrix, and a camera is mounted on a lower side of the substrate. Herein, since the transmitting hole is in the vacuum state, the upper substrate and the lower substrate may bend. Also, because of the changes in the refractive index between the upper substrate and the lower substrate, and the internal reflection, spectroscopy of visible light may occur. Therefore, the spectrum mura such as a Camera Lens Flare may occur on the plane of the panel and on the image taken by the camera.

The present invention removes the spectrum mura caused by the bending of the glass substrate by maintaining the transmitting part or the periphery of the transmitting part at the atmospheric pressure condition. Also, the present invention removes the spectrum mura caused by the changes in the refractive index by placing the transmitting material between the transmitting hole and the camera hole.

Hereinafter, the present invention described with reference to FIG. 1 to FIG. 22 is summarized in brief. FIG. 1 and FIG. 2 schematically illustrate an overall structure of the present invention, and the embodiments of the present invention are shown in FIG. 3 to FIG. 22.

In the first embodiment of the present invention, as shown in FIG. 3, there is no seal between the display area and the first non-display area 301d in which the transmitting hole is formed. Therefore, the display area and the non-display area 301d are filled with liquid crystal. Since liquid crystal has a refractive index similar to a refractive index of glass, the diffraction pattern does not occur in the periphery of the transmitting hole 301g according to the first embodiment of the present invention.

In the second embodiment of the present invention, as shown in FIG. 4 and FIG. 5, the first non-display area is surrounded by the first seal 301e and the second seal 301f, and the column spacer 301h is formed in the transmitting hole 301g. Since depression of the upper substrate in the first non-display area does not occur by the use of the first seal 301e and the second seal 301f, the diffraction pattern does not occur in the periphery of the transmitting hole 301g according to the second embodiment of the present invention. The first non-display area 301d surrounded with the first seal 301e and the second seal 301f may be in the vacuum state; but the first non-display area 301 may be in the atmospheric pressure condition by opening a portion of seals or may be filled with the air.

In the third embodiment of the present invention, as shown in FIG. 6, the first non-display area is surrounded with the first seal 301e and the second seal 301f. Since depression of the upper substrate in the first non-display area does not occur by the use of the first seal 301e and the second seal 301f, the diffraction pattern does not occur in the periphery of the transmitting hole 301g according to the third embodiment of the present invention. The first non-display area 301d surrounded with the first seal 301e and the second seal 301f may be in the vacuum state, but the first non-display area 301 may be in the atmospheric pressure condition by opening a portion of seals or may be filled with the air.

In the fourth embodiment of the present invention, as shown in FIG. 7 to FIG. 10, the transmitting part is surrounded with the first seal 301e, the display area pass through the transmitting part, and liquid crystal is injected into the transmitting part. Also, in the fourth embodiment of the present invention, as shown in FIG. 11 to FIG. 13, the transmitting part is isolated from outside by the first seal 301e, and the transmitting part is filled with the filling material. Also, in the fourth embodiment of the present invention, as shown in FIG. 14 to FIG. 16, the first non-display area is isolated from the display area by the first seal 301e, and the transmitting-hole column spacer is formed in the transmitting hole 301t. The transmitting-hole column spacer 301t may be a filling material in a broad sense. The diffraction pattern does not occur in the periphery of the transmitting hole 301g according to the fourth embodiment of the present invention by filling the transmitting part surrounded with the first seal with liquid crystal having the refractive index similar to that of glass, by filling the transmitting part isolated from outside by the first seal with the filling material having the refractive index similar to that of glass, or by forming the column spacer having the refractive index similar to that of glass in the transmitting hole of the transmitting part that is not surrounded by seal.

In the fifth embodiment of the present invention, as shown in FIG. 17 and FIG. 18, the second seal 301f surrounds the first non-display area except the transmitting part, and therefore, the transmitting part is at the atmospheric pressure condition. In the fifth embodiment of the present invention, as shown in FIG. 19 and FIG. 20, the second seal 301f surrounds the first non-display area except the transmitting part, in which state the transmitting material having the refractive index similar to that of glass is formed in the transmitting hole of the transmitting part. In the fifth embodiment of the present invention, as shown in FIG. 21 and FIG. 22, since the second seal 301f is only formed on the opposite side of the display area (A/A) in the first non-display area, wherein the transmitting hole 301g is formed between the display area (A/A) and the second seal 301f, the entirety of the first non-display area is exposed to the outside in the atmospheric pressure condition. The diffraction pattern does not occur in the periphery of the transmitting hole 301g according to the fifth embodiment of the present invention by filling the predetermined part including the transmitting part and a part of the first non-display area with air (at the atmospheric pressure condition), by forming the transmitting material in the transmitting hole under a condition where the transmitting part and a portion of the first non-display area are filled with air, or by filling the entirety of the first non-display area with air.

In the present invention described above, a upper polarizing film 312 is attached to a upper surface of the upper substrate 301a in which the transmitting hole 301g is formed, A upper polarizing film hole may be formed at a position corresponding to the transmitting hole 301g, wherein the upper polarizing film hole and the transmitting hole are the same size, or size of the upper polarizing film hole is larger than that of the transmitting hole. The upper polarizing film hole enables external light to be relatively better transferred to a camera lens through the transmitting hole 301g. However, the upper polarizing film hole may not be formed in the upper polarizing film 312.

For example, in the display apparatus according to the present invention of FIG. 3. FIG. 4, FIG. 6, FIG. 17 and etc., the upper polarizing film hole is not formed in the upper polarizing film 312. However, in the display apparatus according to the present invention of FIG. 8, FIG. 14, FIG. 16 FIG. 19, FIG. 21 and etc., the upper polarizing film hole is formed in the upper polarizing film 312.

Hereinafter, the display apparatus according to the present invention is described with reference to FIG. 23 and FIG. 24.

FIG. 23 is a flowchart illustrating a method of manufacturing a display apparatus according to an embodiment of the present invention. FIG. 24 is a table showing various kinds of materials which form one of the filling material, the column spacer, and the transmitting material which are formed in the transmitting hole or the transmitting part, in the display apparatus according to an embodiment of the present invention.

First, to manufacture the display apparatus according to the present invention, a black matrix (BM) is deposited on an upper substrate (S102).

The transmitting hole 301g is formed by removing at least one black matrix corresponding to the camera lens from among a plurality of black matrixes deposited in the first non-display area 301d of the upper substrate 301a in operation S104.

R, G, and B color filters are sequentially deposited on a display area in the upper substrate 301a. If necessary, a transparent electrode to inform a common electrode is deposited on the display area in the upper substrate, too (S106). It is preferable to deposit the common electrode only on the display area similarly to the color filter, but if the common electrode is deposited on the non-display area, a process of removing the common electrode deposited on the transmitting hole may be added. However, if the common electrode is formed by a material having a refractive index similar to that of glass, the common electrode deposited on the transmitting hole may not be removed.

An overcoating layer is deposited on the plane of the upper substrate 301a (S108). The over coating layer is formed by organic materials, inorganic materials or organic/inorganic material. The materials forming the over coating layer generally have a refractive index similar to that of glass. Therefore, even though the over coating layer (OC) is deposited on the transmitting hole of the upper substrate, it is not need to perform an additional process of removing the over coating layer.

After manufacturing a color filter substrate by using the process described above (S110), a driving device array substrate is manufactured by depositing a variety of layers on the lower substrate 301b (S112). That is, the driving device array substrate is manufactured by forming a gate electrode on the lower substrate and sequentially depositing a gate insulator film, a data line, a pixel electrode, and etc. on it. The color filter substrate and the driving device array substrate may be manufactured simultaneously in the different processes.

A resin is formed in the transmitting hole or the transmitting part, wherein the resin is used as the filling material described with reference to FIG. 11 to FIG. 13 in the fourth embodiment of the present invention, or the transmitting-hole column spacer 301t described with reference to FIG. 14 and FIG. 15 in the fourth embodiment of the present invention, or transmitting material described with reference to FIG. 19 to FIG. 22 in the fifth embodiment of the present invention (S114). The resin may be formed in the upper substrate 301a or the lower substrate 301b.

Various materials shown in FIG. 24 as well as materials shown in the Table 1 may be used as the resin applied to the present invention.

In FIG. 24a, various kinds of synthetic resins usable as resin and refractive indexes thereof are illustrated. The synthetic resin applied to the present invention may be Epoxy, Polymethylmethacrylate, Polyacrylate, Polycarbonate, Polystyrene, Polystyrene Acrylonitrile, PVC, PVT, Polybutadiene, Polyvinyltetrahydrofuran, Polyvinylthiophene, Polyester, Polyethylene, Polypropylene, Polytetrafluoroethylene, Polytrifluorochloroethylene, Polyvinylacetate, Polyurethane, Cyclo Olefin polymer, Nylon or the like.

In FIG. 24b, the names of various kinds of Epoxy among the material used as the resin are especially illustrated. As the kinds of epoxy, there are DGEBA Type Epoxy, DGEBF Type Epoxy, Novolac Type Epoxy, Brominated Epoxy, Cycloaliphatic Epoxy, Rubber Modified Epoxy, Aliphatic Polyglycidyl Type Epoxy, Glycidyl Amine Type Epoxy, etc.

In FIG. 24c, the name of various kinds of materials used as a synthetic resin lens among the material used as the resin, and refractive indexes of each of them are illustrated. In particular, in FIG. 24c, the name of various kinds of synthetic resin lenses made by Mitsui of Japan company and refractive indexes of each of them are illustrated. The synthetic resin applied to the present invention may be Poly carbonate, Acrylic(R.I.1.60), Middle Inex, ADC(CR-39(R)RAV(R)), Trivex or the like. Also, the product made by Mitsui among the synthetic resin lenses applied to the present invention may be MR-8, MR-7, MR-10 or MR-174.

In FIG. 24d, chemical formulas of the materials used as the resin, the names of them and refractive indexes of each of them are illustrated. Other materials applied to the present invention may be carbon tetrachloride(CCl4), Tribromomethane(CHBr3), Carbon disulfide(CS2), Acetic acid(CH3COOH), Acetone(CH3COCH3), Butanol(C4H10O), Cinnamaldehyde(C9H8O), cyclohexane(C6H12), Ethanol, Ethyl Salicylate(C9H10O3), Ethylene glycol(C2H4(OH)2), Glycerol(C3H5(OH)3), Methanol, Methyl Salicylate or the like.

As shown in FIG. 24, various kinds of resins having a refractive index similar to that of glass may be formed in the transmitting hole of the present invention.

The above-described resin may be formed in the upper substrate or the lower substrate through different processes, according to the shape of the panel that has been described in the fourth embodiment or the fifth embodiment of the present invention. Also, the resin may be formed in the upper substrate or the lower substrate through different processes, according to the state (one of liquid, solid, and semisolid) of the resin that is injected into the upper substrate or the lower substrate.

A seal is formed in the upper substrate or the lower substrate (S116). The seal may be formed in various shapes as shown in FIG. 1 to FIG. 22.

In the above description, after forming the resin in the upper substrate or the lower substrate, the seal is formed, but the order of manufacturing them may be changed. That is, the order of operation S114 of forming the resin and operation S116 of forming the seal may be variously changed according to the state (one of liquid, solid, and semisolid) of injected resin and the position of injected resin.

Finally, the display apparatus according to the present invention is completed by bonding the upper substrate and the lower substrate by using the seal (118), and injecting liquid crystal into a liquid crystal layer. If the liquid crystal is injected into the liquid crystal layer, the process of forming the resin described above (S114) may be omitted. Also, if the transmitting part is maintained in the atmospheric pressure condition, operation S114 of forming the resin may not be performed.

Accordingly, the liquid crystal is injected into the non-display area having the transmitting hole formed in the predetermined portion of the panel corresponding to the camera, or the column spacer is formed in the non-display area having the transmitting hole formed in the predetermined portion of the panel corresponding to the camera so as to prevent the depression of the upper substrate, thereby preventing the depression of the upper substrate in the periphery of the transmitting hole, and preventing the mura from the display area.

Also, the transmitting part having the transmitting hole formed in the non-display area of the panel corresponding to the camera is sealed by the use of seal, and then the inside is filled with any one filling material of solid, liquid, and gas. Thus, the inner refractive index of the transmitting part having the transmitting hole is similar to the refractive index of the substrate so that it is possible to prevent the diffraction in the periphery of the transmitting hole, and to prevent the diffraction pattern from the image taken by the camera.

Moreover, by maintaining the transmitting part (where the transmitting hole is formed to correspond to the camera in the non-display area of the panel) in the atmospheric pressure condition, the present invention prevents the periphery of the transmitting hole from being recessed and prevents the occurrence of spectrum mura (diffraction pattern), thus improving the quality of images captured by the camera.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A display apparatus comprising:
a display unit having a panel provided with lower and upper substrates sealed with having liquid crystal filled therebetween; and
a guide frame, which supports the display unit,
wherein the guide frame includes:
a guide sidewall, which guides a lateral side of the panel; and
a panel supporter, which supports the panel,
wherein a camera receiving part with a camera mounted thereon is disposed in a first panel supporter of the panel supporter,
a transmitting hole for transmitting light to the camera is disposed in a black matrix of a first non-display area to be placed on the first panel supporter of the upper substrate,
a display area of the panel and the first non-display area are filled with liquid crystal,
and an upper polarizing film, which covers the display area and the first non-display area in which the transmitting hole is formed, is attached to a upper surface of the upper substrate.

2. The display apparatus according to claim 1, wherein a common electrode is disposed in the black matrix, and the transmitting hole is formed by etching the black matrix and the common electrode together.

3. The display apparatus according to claim 1, wherein a seal for sealing the upper substrate and the lower substrate is disposed in the periphery of the first non-display area.

4. The display apparatus according to claim 1, wherein a camera hole corresponding to the transmitting hole is disposed in the first panel supporter.

5. A display apparatus comprising:
a display unit having a panel which is provided with lower and upper substrates sealed with liquid crystal filled therebetween; and
a guide frame, which supports the display unit,
wherein the guide frame includes:
a guide sidewall, which guides a lateral side of the panel; and
a panel supporter, which supports the panel,
wherein a camera receiving part with a camera mounted thereon is disposed in a first panel supporter of the panel supporter, a transmitting hole for transmitting light to the camera is disposed in a black matrix of a first non-display area to be placed on the first panel supporter of the upper substrate, a first seal is disposed between a display area of the panel and the first non-display area, and liquid crystal is filled only in the display area, an upper polarizing film, which covers the display area and the first non-display area in which the transmitting hole is formed, is attached to a upper surface of the upper substrate, and the first non-display area is at atmospheric pressure.

6. The display apparatus according to claim 5, wherein a second seal is disposed in the periphery of the first non-display area.

7. The display apparatus according to claim 5, wherein the first panel supporter is formed in the shape of ‘∪’.

8. The display apparatus according to claim 5, wherein the first panel supporter is formed in the shape of ‘∩’, and a camera hole corresponding to the transmitting hole is formed in the first panel supporter.

9. The display apparatus according to claim 5, wherein at least one column spacer is disposed in the periphery of the transmitting hole in the first non-display area.

10. The display apparatus according to claim 9, wherein the column spacer in the periphery of the transmitting hole is formed by the same process as those of column spacers in the display area of the upper substrate.

11. A display apparatus comprising:
a display unit having a panel provided with lower and upper substrates sealed with liquid crystal filled therebetween; and
a guide frame, which supports the display unit,
wherein a transmitting hole for transmitting light to a camera provided below the panel is disposed in a black matrix of a first non-display area of the upper substrate, and
the first non-display area is divided into a transmitting part for the transmitting hole formed therein, and a vacuum part corresponding to the remaining parts except the transmitting part, wherein the transmitting part is sealed by a first seal formed along the interface between a display area of the panel and the first non-display area while being isolated from the vacuum part, the transmitting part is filled with a filling material, an upper polarizing film, which covers the display area and the first non-display area in which the transmitting hole is formed, is attached to a upper surface of the upper substrate, and the filling material is liquid crystal.

12. The display apparatus according to claim 11, wherein the first seal is curved toward a second seal direction for sealing the periphery of the non-display area to surround the transmitting part, and the transmitting part is filled with the liquid crystal injected into the display area.

13. The display apparatus according to claim 12, wherein the transmitting part is sealed by the first seal and some portions of the second seal, and is isolated from the vacuum part.

14. The display apparatus according to claim 12, wherein the transmitting part is sealed only by the first seal, and is isolated from the vacuum part.

15. The display apparatus according to claim 11, wherein the first seal is curved toward a second seal direction for sealing the periphery of the non-display area to surround the transmitting part, and is formed along the interface between the transmitting part and the display area.

16. The display apparatus according to claim 15, wherein the filling material is a solid, liquid, or gas material having a refractive index between about 1.3 to about 1.7.

17. The display apparatus according to claim 15, wherein the filling material is liquid crystal.

18. The display apparatus according to claim 15, wherein the filling material is a transmitting-hole column spacer, which is formed together with a column spacer, for maintaining a cell gap between the upper substrate and the lower substrate in the display area.

19. The display apparatus according to claim 11, wherein a common electrode is disposed in the black matrix, and the transmitting hole is formed by etching the black matrix together with the common electrode.

20. The display apparatus according to claim 11, wherein the guide frame includes:
a guide sidewall, which guides a lateral side of the panel; and
a panel supporter, which supports the panel.

21. A display apparatus comprising:
a display unit having a panel provided with lower and upper substrates sealed with liquid crystal filled therebetween; and
a guide frame, which includes a guide sidewall and a panel supporter so as to support the display unit;
wherein a transmitting hole for transmitting light to a camera provided below the panel is disposed in a black matrix of a first non-display area of the upper substrate,
a first seal is disposed along the interface between a display area of the panel and the first non-display area, a transmitting-hole column spacer is disposed in the transmitting hole, wherein the transmitting-hole column spacer is formed together with a column spacer for maintaining a cell gap between the upper substrate and the lower substrate, an upper polarizing film, which covers the display area and the first non-display area in which the transmitting hole is formed, is attached to a upper surface of the upper substrate, and the column spacer is resin.

22. The display apparatus according to claim 21, wherein a second seal is disposed in the periphery of the first non-display area.

23. The display apparatus according to claim 21, wherein a camera receiving part with a camera mounted thereon is formed in a first panel supporter of the panel supporter, and the first non-display area is placed on the first panel supporter.

24. The display apparatus according to claim 23, wherein the first panel supporter is formed in the shape of ‘∪’.

25. The display apparatus according to claim 23, wherein the first panel supporter is formed in the shape of ‘∩’, and a camera hole corresponding to the transmitting hole is formed in the first panel supporter.

26. A display apparatus comprising:
an upper substrate, which is provided with a black matrix in a first non-display area; and
a lower substrate, which includes a plurality of pixels in a display area, wherein the lower substrate is bonded to the upper substrate with a liquid crystal layer interposed therebetween,
wherein a transmitting hole for transmitting light to a camera provided below the lower substrate is disposed in the black matrix of the first non-display area, and
a first seal is disposed along the interface between the first non-display area and the display area, wherein the first seal is curved toward a second seal direction in the periphery of the first non-display area so as to isolate a transmitting part with the transmitting hole from a vacuum part corresponding to the remaining parts of the first non-display area except the transmitting part, the transmitting part is filled with a filling material, an upper polarizing film, which covers the display area and the first non-display area in which the transmitting hole is formed, is attached to a upper surface of the upper substrate, and the filling material is liquid crystal or resin.

27. The display apparatus according to claim 26, wherein the transmitting hole penetrates through the display area, and the transmitting part is filled with the liquid crystal injected into the display area.

28. The display apparatus according to claim 26, wherein the first seal is disposed along the interface between the transmitting part and the display area.

29. The display apparatus according to claim 28, wherein the filling material is a solid, liquid, or gas material having a refractive index between about 1.3 to about 1.7, and the material is resin.

30. A display apparatus comprising:
a display unit comprising a panel which is sealed, with liquid crystal being charged between an upper substrate and a lower substrate; and
a guide frame supporting the display unit,
wherein,
the guide frame comprises: a guide side wall guiding a side surface of the panel; and a panel supporting part supporting the panel,
a camera receiving part receiving a camera is formed at a first panel supporting part of the panel supporting part,
a transmitting hole which transmits light to the camera is formed at a black matrix in a first inactive area which is formed at the first panel supporting part, in the upper substrate,
in a space between the upper substrate and the lower substrate, a portion corresponding to the first non-display area is exposed in an atmospheric pressure state, and
an upper polarizing film, which covers the display area and the first non-display area in which the transmitting hole is formed, is attached to a upper surface of the upper substrate.

31. The display apparatus of claim 30, wherein the transmitting hole is formed by etching the black matrix.

32. The display apparatus of claim 30, wherein a seal is formed in the first non-display area other than the transmitting hole, the transmitting part including the transmitting hole and a portion of the periphery of the transmitting hole, the seal sealing a space between the upper substrate and the lower substrate.

33. The display apparatus of claim 30, wherein a camera hole corresponding to the transmitting hole is formed in the first panel supporter.

34. The display apparatus of claim 30, wherein in the space between the upper substrate and the lower substrate, a transmitting material formed of resin having a refractive index from about 1.3 to about 1.7 is formed in a portion of the space with the transmitting hole formed therein.

35. The display apparatus of claim 34, wherein the transmitting material is formed in a column spacer type.

36. The display apparatus of claim 30, wherein in the first non-display area, a first non-display area column spacer is formed in a periphery of the transmitting hole.

37. The display apparatus of claim 30, wherein,
a first seal is formed in a periphery of the display area of the panel,
a second seal is formed in the first non-display area,
the second seal is connected to the first seal,
in the first non-display area, a portion of the first non-display area other than the transmitting hole, the transmitting part including the transmitting hole and the periphery of the transmitting hole forms a sealed space, and
a portion of the transmitting part and the periphery of the transmitting part is exposed at an atmospheric pressure condition.

38. The display apparatus of claim 30, wherein,
a first seal is formed in a periphery of the display area of the panel,
a second seal is formed in the first non-display area, and
the second seal is formed on the opposite side of the display area, wherein the transmitting hole is formed between the display area and the second seal, thereby exposing the entire first non-display area at an atmospheric pressure condition.

39. The display apparatus of claim 38, wherein in the space between the upper substrate and the lower substrate, a transmitting material having a refractive index from about 1.3 to about 1.7 is formed in a portion of the space with the transmitting hole formed therein.

40. The display apparatus of claim 37, wherein in the space between the upper substrate and the lower substrate, a transmitting material formed of resin having a refractive index from about 1.3 to about 1.7 is formed in a portion of the space with the transmitting hole formed therein.

41. The display apparatus of claim 30, wherein the first panel supporter is formed in the shape of ‘∪’.

42. The display apparatus of claim 30, wherein,
the first panel supporter is formed in the shape of ‘∩’, and
a camera hole corresponding to the transmitting hole is formed in the first panel supporter.

43. The display apparatus of claim 21 or 26 or 29 or 34 or 40, wherein,
the resin is any one of Epoxy, Polymethylmethacrylate, Polyacrylate, Polycarbonate, Polystyrene, Polystyrene Acrylonitrile, PVC, PVT, Polybutadiene, Polyvinyltetrahydrofuran, Polyvinylthiophene, Polyester, Polyethylene, Polypropylene, Polytetrafluoroethylene, Polytrifluorochloroethylene, Polyvinylacetate, Polyurethane, Cyclo Olefin polymer and Nylon.

44. The display apparatus of claim 43, wherein,
the Epoxy is any one of DGEBA Type Epoxy, DGEBF Type Epoxy, Novolac Type Epoxy, Brominated Epoxy, Cycloaliphatic Epoxy, Rubber Modified Epoxy, Aliphatic Polyglycidyl Type Epoxy and Glycidyl Amine Type Epoxy.

45. The display apparatus of claim 21 or 26 or 29 or 34 or 40, wherein,
the resin is any one of carbon tetrachloride(CCl4), Tribromomethane(CHBr3), Carbon disulfide(CS2), Acetic acid(CH3COOH), Acetone(CH3COCH3), Butanol(C4H10O), Cinnamaldehyde(C9H8O), cyclohexane(C6H12), Ethanol, Ethyl Salicylate(C9H10O3), Ethylene glycol(C2H4(OH)2), Glycerol(C3H5(OH)3), Methanol and Methyl Salicylate.

46. The display apparatus of claim 1 or 5 or 11 or 21 or 26 or 30, wherein,
a upper polarizing film hole corresponding to the transmitting hole is formed in the upper polarizing film.
